(19) United States
(12) Patent Application Publication
(10) Pub. No.: US 2026/0047590 A1
(43) Pub. Date: Feb. 19, 2026

(54) POPCORN MACHINES WITH PREHEATING SYSTEMS

(71) Applicant: C. Cretors & Company, Wood Dale, IL (US)

(72) Inventors: Kristen A. Brennan, Arlington Heights, IL (US); Charles D. Cretors, Lake Forest, IL (US); Nenad Vidojevic, Chesterton, IN (US); Karl R. Heinze, Wood Dale, IL (US); Athanasios Kremmydas, Wood Dale, IL (US); Patrick John Concannon, Wood Dale, IL (US)

(21) Appl. No.: 19/297,991

(22) Filed: Aug. 12, 2025

Related U.S. Application Data
(60) Provisional application No. 63/683,184, filed on Aug. 14, 2024.

(51) Int. Cl. A23L 7/183; A23L 5/10; A23P 30/38

(52) U.S. Cl. CPC A23L 7/183; A23L 5/11; A23P 30/38

(57) ABSTRACT

Popcorn making systems for use with a hybrid popping process are disclosed herein. The hybrid popping process can involve using air to preheat corn kernels, then heating the preheated corn kernels in oil to pop them. In some embodiments, a popcorn making system includes a feed assembly, a preheating assembly, and a popping assembly. The feed assembly can output corn kernels at a feed rate. The preheating assembly can include a drum, a moving device disposed inside the drum, and an air mover and a heater external to the drum. The air mover and the heater can preheat corn kernels moving through the drum. The popping assembly can receive the preheated corn kernels from the preheating assembly, and can heat and thereby pop the preheated corn kernels in cooking oil.

### CROSS-REFERENCE TO RELATED APPLICATION

The present application claims the benefit of U.S. Provisional Patent Application No. 63/683,184, filed Aug. 14, 2024, entitled “POPCORN MACHINES WITH PREHEATING SYSTEMS” the disclosure of which is incorporated herein by reference in its entirety.

### TECHNICAL FIELD

The present technology relates generally to popcorn machines and, more particularly, to continuous popcorn machines with ingredient preheating systems.

### BACKGROUND

In typical popcorn machines designed for commercial or industrial popcorn production, thermostats are used to control the popping cycles of high output kettles. More particularly, feedback from the thermocouples is used to control heating elements that heat the kettles and corn kernels therein at rates that prevent burning and yet ensure that the corn kernels pop. The controlled cooking cycle in these high output kettles can produce consistent and high-quality popcorn. In previous designs of continuous popcorn machines, however, attempts to produce popcorn of similar quality have been less successful.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present technology.

FIG. 1 is a schematic block diagram of a popcorn making system configured in accordance with embodiments of the present technology.

FIG. 2 is an isometric view of a popcorn making system configured in accordance with embodiments of the present technology.

FIG. 3 is an isometric view of a feed assembly of the popcorn making system of FIG. 2 configured in accordance with embodiments of the present technology.

FIG. 4 is an isometric view of the feed assembly of FIG. 3 with selected components removed for illustrative purposes.

FIGS. 5A and 5B are front isometric and rear isometric views, respectively, of a preheating assembly of the popcorn making system of FIG. 2 configured in accordance with embodiments of the present technology.

FIGS. 6A-6C are front isometric, rear isometric, and rear views, respectively, of the preheating assembly of FIG. 5A with selected components removed for illustrative purposes.

FIG. 7A is a top isometric view of the preheating assembly of FIG. 5A with selected components removed for illustrative purposes, and FIG. 7B is a rear isometric view of portions of a drum and a moving device of the preheating assembly of FIG. 5A.

FIG. 8 is an isometric view of popcorn popper and a popper heating unit of the popcorn making system of FIG. 2 configured in accordance with embodiments of the present technology.

FIG. 9 is an enlarged isometric view of the popcorn popper of FIG. 8 configured in accordance with embodiments of the present technology.

FIG. 10 is an enlarged isometric view of the popcorn popper of FIG. 9 with selected components removed for illustrative purposes.

FIG. 11 is an enlarged front cross-sectional view of the popcorn popper of FIG. 9 configured in accordance with embodiments of the present technology.

FIG. 12 is a schematic diagram illustrating operation of the popcorn popper and the popper heating unit of FIG. 8 configured in accordance with embodiments of the present technology.

FIG. 13 is a flowchart illustrating a method of operating a popcorn making system in accordance with embodiments of the present technology.

FIG. 14 is an isometric view of an auger assembly configured in accordance with embodiments of the present technology.

FIG. 15 is an isometric view of another auger assembly configured in accordance with embodiments of the present technology.

FIGS. 16A and 16B are enlarged perspective views of ribbon flighting and full flighting zones, respectively, of an auger included in the auger assembly of FIG. 15 configured in accordance with embodiments of the present technology.

FIGS. 17A and 17B are enlarged side and top views, respectively, of agitators included in the auger assembly of FIG. 15 and configured in accordance with embodiments of the present technology.

FIG. 18 is an enlarged perspective view of sifter rods included in the auger assembly of FIG. 15 and configured in accordance with embodiments of the present technology.

### DETAILED DESCRIPTION

### I. Overview

Embodiments of the present technology are generally directed to systems, devices, and associated methods for heating and cooking a food product, such as corn kernels to make popcorn. In some embodiments, the present technology is directed to popcorn making systems that implement a hybrid popping process to produce popcorn at a higher rate than conventional popcorn machines. The hybrid popping process can include using hot air to preheat corn kernels without drying them out or causing them to pop, then further heating the preheated kernels in, e.g., cooking oil to pop them. Some embodiments of the popcorn making systems described herein can reduce the residence time of the corn kernels in the popping system to about 30-50% of the residence time required by existing machines that use only cooking oil to heat and pop corn kernels, thereby providing a production rate that can potentially be 2-3 times higher (or more) than existing machines. Although embodiments of the present technology are described below primarily in the context of preheating and popping corn kernels to produce popcorn, it will be appreciated that embodiments of the present technology can alternatively or additionally be used to produce or process other forms of food, such as to cook or pop other grains (e.g., sorghum, amaranth, etc.), roast nuts (e.g., peanuts, cashews, pecans, almonds, etc.), roast seeds (e.g., sunflower seeds, pumpkin seeds, lotus seeds, chickpeas, etc.), etc.

In some embodiments, a popcorn making system includes a feed assembly, a preheating assembly positioned downstream of the feed assembly, and a popping assembly positioned downstream of the preheating assembly. The feed assembly can be configured to receive corn kernels (and/or other ingredients) and output the corn kernels to the preheating assembly at a given feed rate. In some embodiments, the preheating assembly can include (i) a vessel, e.g., a drum, positioned to receive the corn kernels from the feed assembly, (ii) a moving device, e.g., an auger, operably disposed inside the drum and configured to move the corn kernels through the drum, (iii) an air mover, e.g., a fan, positioned external to the drum, and (iv) a heater positioned external to the drum. The fan can be configured to direct air over the heater to heat the air and then flow the heated air around the drum to heat the drum and preheat the corn kernels moving therethrough. In some embodiments, the popping assembly can include, e.g., a popcorn popper having (i) a trough, (ii) a cover disposed over the trough to define an internal chamber therebetween that receives the preheated corn kernels from the preheating assembly and can also receive cooking oil, (iii) a moving device, e.g., an auger, operably disposed inside the internal chamber and configured to move the preheated corn kernels and cooking oil through the internal chamber, and (iv) one or more heating units configured to heat the trough and thereby further heat the preheated corn kernels in the cooking oil as they move through the internal chamber, thereby causing the corn kernels to pop.

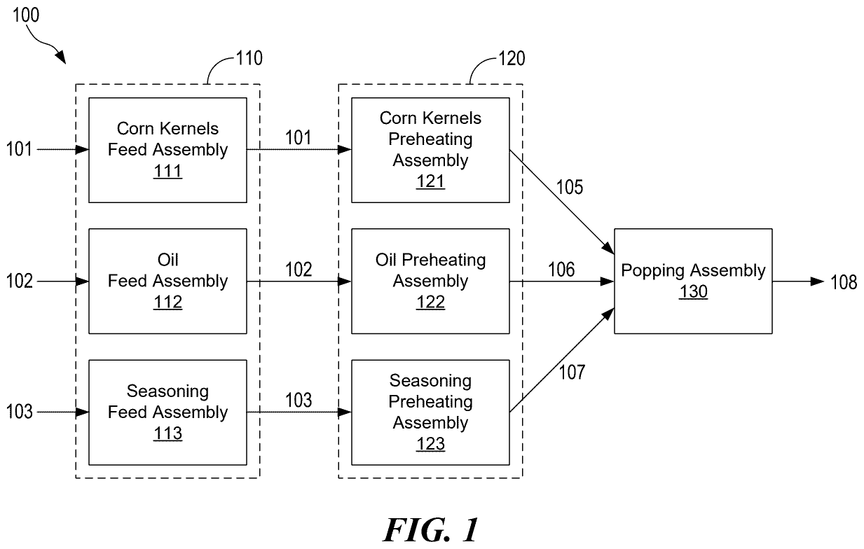

Embodiments of the present technology include popcorn making systems that can consistently produce high-quality popcorn at rates that may be significantly higher than existing machines by using a hybrid (e.g., a two-stage) popping process. Certain details are set forth in the following description and FIGS. 1-13 to provide a thorough understanding of various embodiments of the disclosure. Other details describing well-known structures and systems often associated with popcorn machines, popping chambers, heating systems, etc., and/or the components or devices often associated with the operation and manufacture of popcorn machines, are not set forth below to avoid unnecessarily obscuring the description of the various embodiments of the disclosure.

In the Figures, identical reference numbers identify identical, or at least generally similar, elements. Many of the details, dimensions, and other features shown in the Figures are merely illustrative of particular embodiments of the disclosed technology and may not be drawn to scale. Accordingly, other embodiments can have other details, dimensions, and features without departing from the spirit or scope of the disclosure. In addition, those of ordinary skill in the art will appreciate that further embodiments of the disclosed technologies can be practiced without several of the details described below.

FIG. 1 is a schematic block diagram of a popcorn making system 100 (“system 100”) configured in accordance with embodiments of the present technology. The system 100 can include one or more feed assemblies 110, one or more preheating assemblies 120 positioned downstream of the feed assemblies 110, and a popping assembly 130 positioned downstream of the preheating assemblies 120. The feed assemblies 110 can include (i) a corn kernels feed assembly 111 positioned to receive corn kernels 101, (ii) an oil feed assembly 112 positioned to receive oil 102 (e.g., vegetable oil, canola oil), and/or (iii) a seasoning feed assembly 113 positioned to receive seasonings 103 (e.g., salt, sugar, caramel, butter). The preheating assemblies 120 can include (i) a corn kernels preheating assembly 121 positioned to receive the corn kernels 101 from the corn kernels feed assembly 111, (ii) an oil preheating assembly 122 positioned to receive the oil 102 from the oil feed assembly 112, and/or (iii) a seasoning preheating assembly 123 positioned to receive the seasonings 103 from the seasoning feed assembly 113.

In operation, each of the feed assemblies 111, 112, 113 can receive its respective ingredient 101, 102, 103, and provide the ingredient to the corresponding preheating assembly 121, 122, 123 at a desired rate. For example, the corn kernels 101 can be dumped or otherwise deposited into the corn kernels feed assembly 111 in a convenient manner, and the corn kernels feed assembly 111 can provide the received corn kernels 101 to the corn kernels preheating assembly 121 at a specific and/or desired rate (e.g., in grams per minute). In some embodiments, each of the feed assemblies 111, 112, 113 also filters the ingredients (e.g., by size), mixes the ingredients (e.g., if there are multiple types of corn kernels received), and/or the like. Likewise, the oil 102 can be dumped or otherwise deposited into the oil feed assembly 112, which can provide the oil 102 to the oil preheating assembly 122. Similarly, the seasonings 103 can be dumped or deposited into the seasoning feed assembly 113, which then provides the seasonings 103 to the seasoning preheating assembly 123.

Each of the preheating assemblies 121, 122, 123 can receive its respective ingredient 101, 102, 103 from the corresponding feed assembly 111, 112, 113 and preheat the ingredient to a desired temperature. For example, (i) the corn kernels preheating assembly 121 can use hot air to produce preheated corn kernels 105, (ii) the oil preheating assembly 122 can use natural gas, induction, and/or the like to produced preheated oil 106, and (iii) the seasoning preheating assembly 123 can likewise use one or more energy sources to produce preheated seasonings 107. As a more specific example, the seasoning preheating assembly 123 can melt sugar into liquid crystal sugar or heat granular sugar until it becomes hot but not yet melted. The popping assembly 130 can receive and further heat the preheated ingredients 105, 106, 107 to, for example, produce cooked products 108 (e.g., popcorn). In some embodiments, one or more of the feed assemblies 111, 112, 113 and/or one or more of the preheating assemblies 121, 122, 123 can be omitted and the respective ingredients directly fed into the popping assembly 130 (or respective preheating assembly 121, 122, 123).

In the foregoing manner, embodiments of the popcorn making system 100 can produce popcorn using a hybrid popping process that includes (i) preheating corn kernels with a first medium (e.g., hot air) and then (ii) further heating the preheated corn kernels in a second medium (e.g., hot oil) until they pop. Likewise, oil and/or seasoning can be preheated before entering the popping assembly for further heating. The following discussion of the figures illustrates example embodiments of popcorn making systems that can implement the hybrid popping process.

### II. Select Embodiments of Popcorn Making Systems

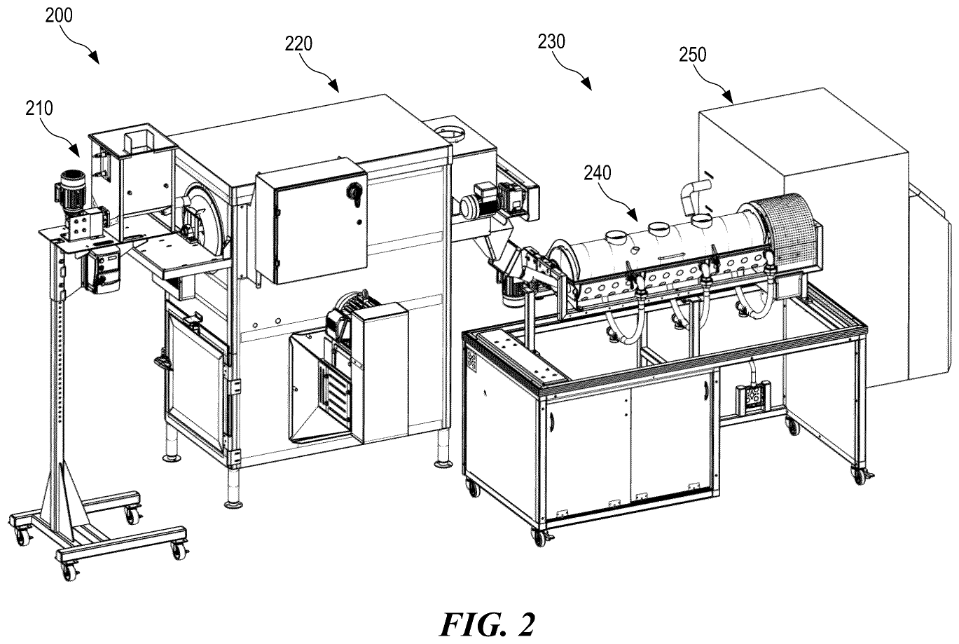

FIG. 2 is an isometric view of a popcorn making system 200 configured in accordance with embodiments of the present technology. The popcorn making system 200 can be an example of the popcorn making system 100 of FIG. 1. The popcorn making system 200 can include a feed assembly 210, a preheating assembly 220 positioned downstream of the feed assembly 210, and a popping assembly 230 positioned downstream of the preheating assembly 220. In the illustrated embodiment, the popping assembly 230 includes a popcorn popper 240 (“popper 240”) positioned downstream of the preheating assembly 220, and a popper heating unit 250 operably coupled to the popper 240. As discussed above with reference to FIG. 1, in operation, the feed assembly 210 can receive and filter, mix, etc. raw ingredients (e.g., corn kernels) and provide the corn kernels to the preheating assembly 220 at a desired rate. The preheating assembly 220 can receive the corn kernels from the feed assembly 210 and preheat the corn kernels to a desired temperature using, e.g., hot air to produce preheated corn kernels. The popping assembly 230 can receive the preheated corn kernels and further heat the preheated corn kernels in, e.g., hot oil to produce cooked products (e.g., popcorn). Therefore, the popcorn making system 200 can implement a popping process (which can be referred to as a “hybrid” or “two-stage” popping process) that involves (i) preheating corn kernels to bring them up to a first temperature or first temperature range (using, e.g., a first medium (e.g., hot air)) and then (ii) further heating the corn kernels to bring them up to a second temperature or second temperature range at which they pop (using, e.g., a second medium (e.g., hot oil)).

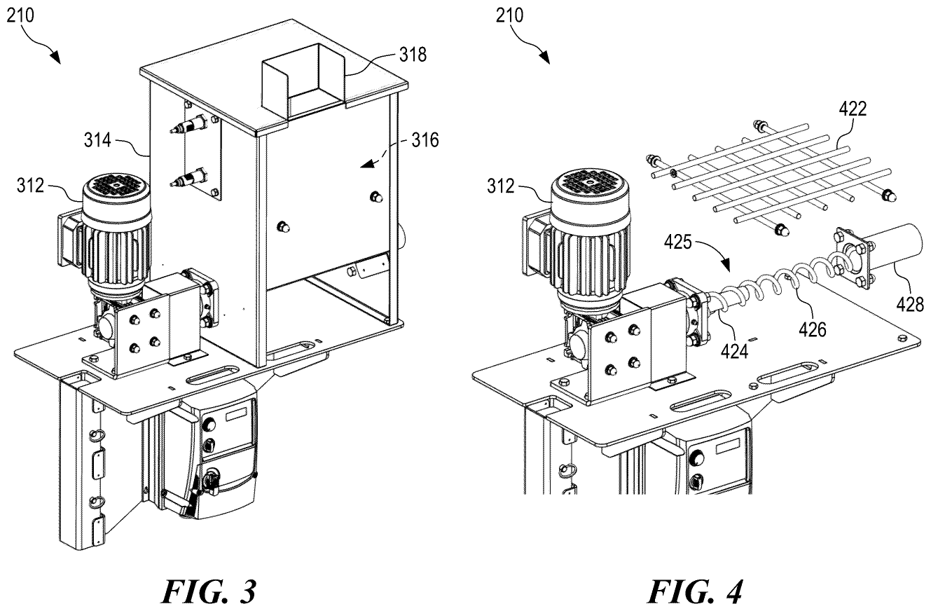

FIG. 3 is an isometric view of the feed assembly 210. The feed assembly 210 can include a motor 312 (e.g., an electric motor) and a housing 314 positioned adjacent the motor 312. The housing 314 can include an opening or inlet 318 to an internal chamber 316. Although the inlet 318 is illustrated on the top of the housing 314, the inlet 318 can be positioned elsewhere in other embodiments, such as in an upper portion of a sidewall of the housing 314. FIG. 4 is an isometric view of the feed assembly 210 with the housing 314 removed for illustrative purposes. The feed assembly 210 can further include a grate, filter, or barrier 422 and an ingredient mover 425. The grate 422 can be coupled to sidewalls of the housing 314 and positioned above the ingredient mover 425. In the illustrated embodiment, the grate 422 includes a plurality of rods arranged in a cross-hatch pattern and can function as a safety feature by preventing a user from placing their hand near the helical member 426 or other moving components of the feed assembly 210 during operation. In other embodiments, the grate 422 can include different components and/or arrangements or, in some embodiments, the grate 422 can be omitted. In the illustrated embodiment, the ingredient mover 425 includes a helical member 426 having a proximal end portion coaxially coupled to a drive shaft 424 that is mechanically driven by of the motor 312. A distal end portion of the helical member 426 can be rotatably received in an outlet 428 that includes a hollow tube extending through a sidewall of the housing 314. In the illustrated embodiment, the helical member 426 is positioned in a lower portion of the internal chamber 316 and configured to contact corn kernels placed therein. The helical member 426 can include an elongate rod, wire, and/or other element formed in a helical shape, so that rotation of the helical member 426 about its longitudinal axis in the appropriate direction drives corn kernels away from the proximal end of the helical member and toward the distal end of the helical member 426 and ultimately out of the housing 314 via the outlet 428.

In operation, corn kernels can be poured, dumped, or otherwise placed in the internal chamber 316 of the housing 314 via the inlet 318. Operation of the motor 312 rotates the shaft 424 and the helical member 426 about its longitudinal axis. As the helical member 426 rotates, it drives the corn kernels out of the housing 314 through the outlet 428. The rate of corn kernels flowing out of the housing 314 can be controlled by the speed of the motor 312 and adjusted as needed to provide a desired kernel flow rate. Although, in the illustrated embodiment, the ingredient mover 425 includes the helical member 426 (e.g., a helical rod or wire), in other embodiments the ingredient mover 425 can include other types of helical members (e.g., a helical blade), an arrangement of rotating blades or paddles, a vibrator, and/or other suitable mechanisms and/or devices for moving corn kernels out of the housing 314. In some embodiments, the bottom of the housing 314 forms a V-shape extending beneath and parallel to the helical member 426 so that the corn kernels at the bottom of the internal chamber 316 are concentrated around the helical member 426 and, accordingly, the helical member 426 can efficiently drive the corn kernels towards the outlet 428. The corn kernels can flow out of the internal chamber 316 and toward, for example, the preheating assembly 220 via the outlet 428 at the desired rate.

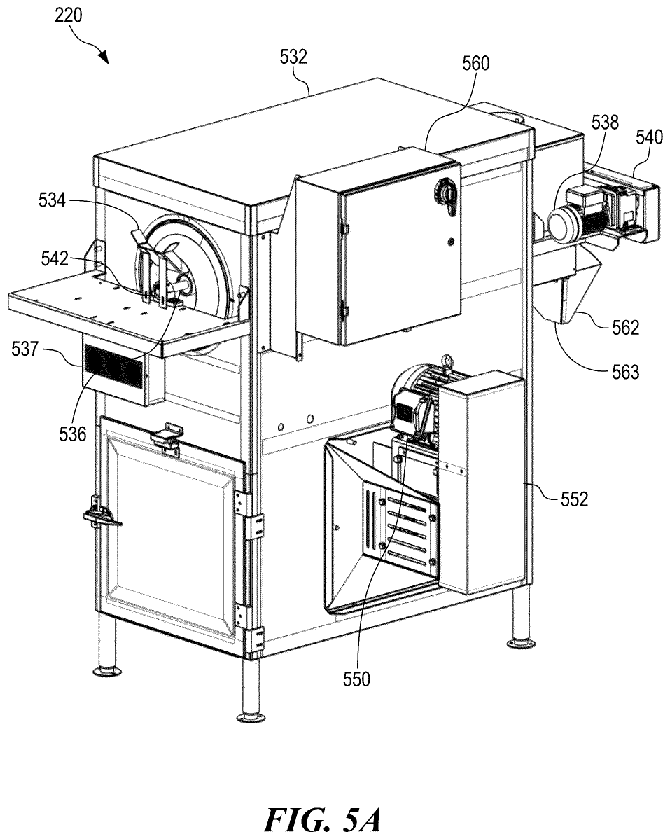

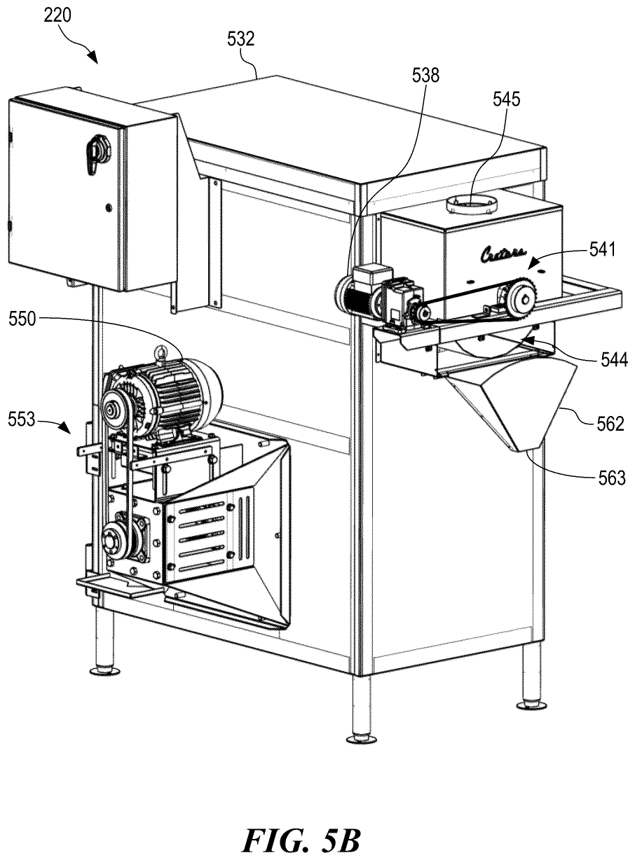

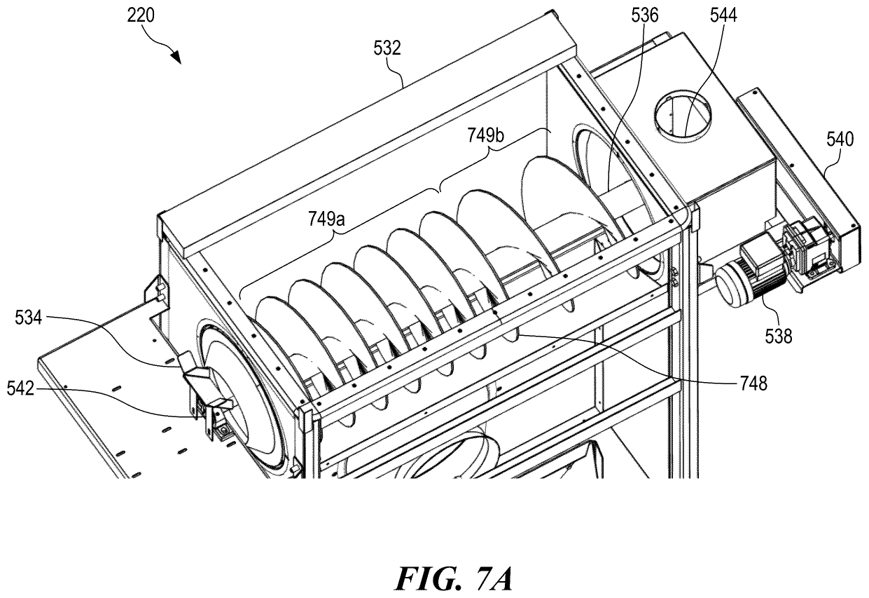

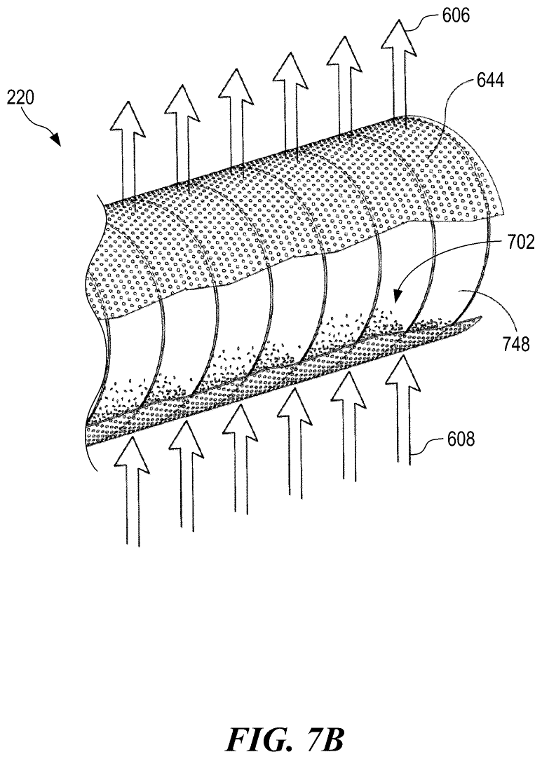

FIGS. 5A and 5B are front isometric and rear isometric views, respectively, of the preheating assembly 220, configured in accordance with embodiments of the present technology. Referring to FIGS. 5A and 5B together, the preheating assembly 220 can include a housing 532, a first shaft 536, a first motor 538 (e.g., a first electric motor), a second motor 550 (e.g., a second electric motor), an outlet chute 562 having an outlet 563, an enclosure 537, and a controller 560. As best illustrated in FIG. 7A, the first shaft 536 extends through the housing 532 and is rotatably supported at a proximal end portion by a bearing 542 coupled to the housing 532. The distal end portion of the first shaft 536 can be rotatably supported by a corresponding bearing. The proximal and/or distal end portions of the first shaft 536 can be supported by additional or alternative structures.

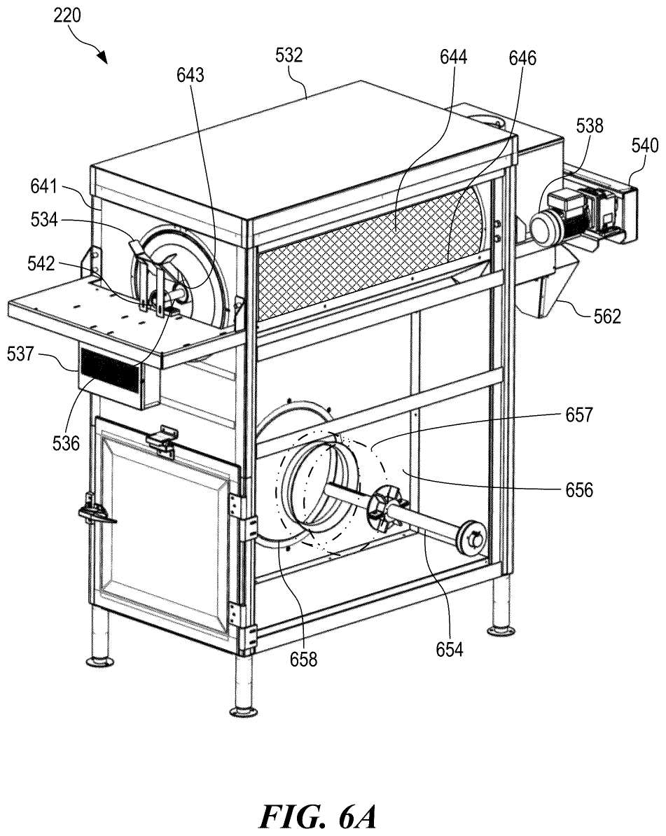

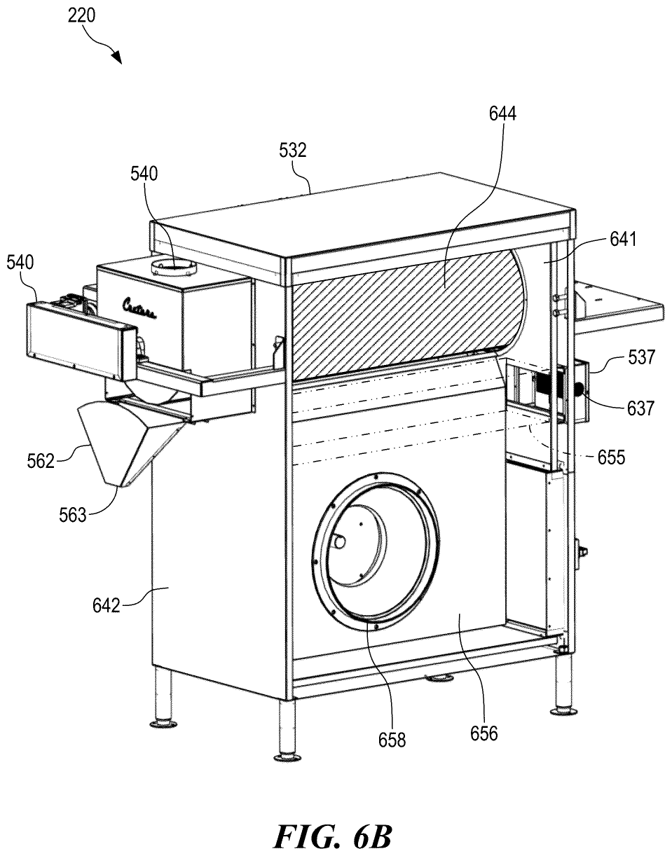

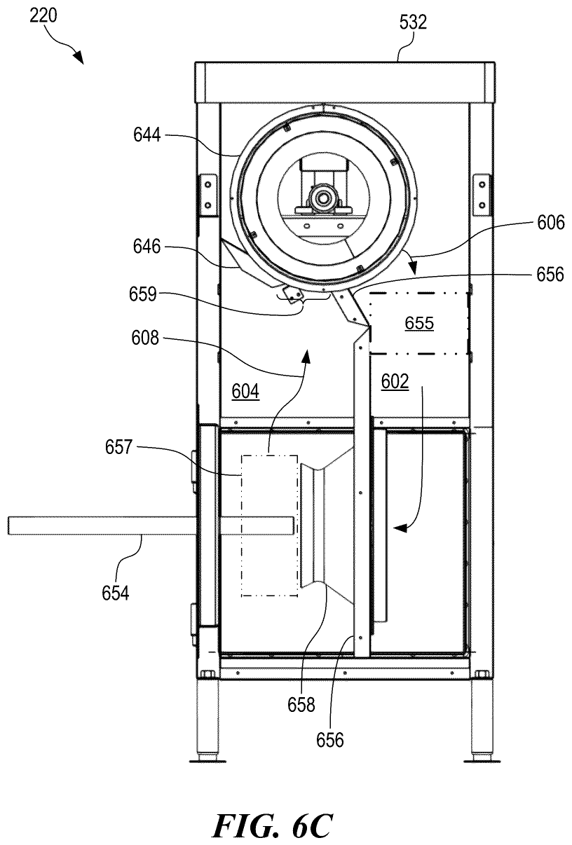

The preheating assembly 220 further includes a first transmission enclosure 540 (FIG. 5A) coupled to the housing 532 and housing a first transmission 541 (FIG. 5B), and a second transmission enclosure 552 (FIG. 5A) coupled to the housing 532 and housing a second transmission 553 (FIG. 5B). FIG. 5B omits the first transmission enclosure 540 and the second transmission enclosure 552 for illustrative purposes. The distal end portion of the first shaft 536 is operably coupled to an output shaft of the first motor 538 via the first transmission 541 (e.g., a gearbox, a drive belt, and/or a clutch, etc.) so that operation of the first motor 538 can rotate the first shaft 536 about its longitudinal axis. In the illustrated embodiment, the first motor 538 is offset from the longitudinal axis of the first shaft 536 and coupled to the housing 532. As described in more detail below, an output shaft of the second motor 550 can be operably coupled to a second shaft (not shown in FIGS. 5A and 5B; shown in FIGS. 6A-6C) via the second transmission 553 (e.g., a gearbox, a drive belt, a clutch, etc.).

The housing 532 can include an inlet 534 (FIG. 5A) proximate (e.g., above) the bearing 542 through which corn kernels from the feed assembly 210 can enter the preheating assembly 220. In the illustrated embodiment, for example, the inlet 534 comprises a ramp along which corn kernels from the outlet 428 (FIG. 4) of the feed assembly 210 can slide into the preheating assembly 220. The outlet chute 562 (best shown in FIG. 5B), is coupled to the housing 532 below an outlet 544 through which preheated corn kernels can exit the preheating assembly 220. In the illustrated embodiment, the outlet chute 562 is shaped, positioned, and oriented to enable a quick drop of the corn kernels from preheating assembly 220 to the popping assembly 230 via the outlet 563, thereby minimizing the transition time during which the corn kernels may dry out. As illustrated in FIG. 5B, the housing 532 can further include a vent 545 (e.g., a circular opening) in an upper portion thereof to which a pipe can be coupled in fluid communication to vent heat, gas, etc. from the interior of the housing 532.

In some embodiments, the controller 560 can include a processor (e.g., a CPU, PLC, etc.) that executes instructions stored on non-transitory computer readable medium, e.g., memory, in response to, e.g., user control inputs. In some embodiments, the processor can communicate with a user interface and display text and graphics via a display and/or receive user control inputs via an input device, such as a touch screen and/or manual control features (buttons, knobs, switches, etc.).

FIGS. 6A and 6B are front isometric and rear isometric views, respectively, of the preheating assembly 220 with the second motor 550, the second transmission enclosure 552, the second transmission 553, left and right side panels of the housing 532, and other selected components removed for illustrative purposes. Referring first to FIG. 6A, the preheating assembly 220 can further include a horizontally disposed cylindrical drum 644, a second shaft 654, a partition 656, an inlet shroud 658 (e.g., a frustoconical component), and a baffle 646. In some embodiments, the drum 644 is attached (e.g., welded) to an auger (not shown in FIG. 6A) which is concentrically positioned within the drum 644 and fixedly attached to the first shaft 536, as discussed in further detail below with reference to FIG. 7A. The drum 644 can extend generally between the inlet 534 and the outlet 544, and extend coaxially to the first shaft 536. In particular, the drum 644 can receive corn kernels via a circular opening 643 in a front panel 641 of the housing 532. As better illustrated in FIG. 7B, the outer wall of the drum 644 is perforated to allow heated air to pass therethrough and can be formed from a metal screen or other perforated sheet metal material.

The second shaft 654 can be operably coupled to the second motor 550 via the second transmission 553 (FIG. 5B). An air mover 657 (illustrated schematically), e.g., an impeller fan, centrifugal fan, axial fan, plug fan, blower, etc., can be fixedly coupled to a distal end portion of the second shaft 654 so that operation of the second motor 550 rotates the air mover 657 about the longitudinal axis of the second shaft 654. The inlet shroud 658 can be mounted to the partition 656 and define an air inlet or opening to the air mover 657. The partition 656 is positioned to divide the interior of the housing 532 into two separate chambers, as better illustrated in FIG. 6C.

Referring next to FIG. 6B, the preheating assembly 220 can further include a heater 655 (shown schematically) operably positioned within the housing 532. The heater 655 can include an electrical resistive heater, an atmospheric or gas-burning heater, an inductive heater, etc. In the illustrated embodiment, the heater 655 is operably mounted to one or both of the front panel 641 and/or the rear panel 642 of the housing 532 (e.g., via suitable brackets, fasteners, etc.) and can extend horizontally and generally parallel to the drum 644. In other embodiments, the heater 655 can be operably mounted and/or positioned in other locations within the housing 532 to heat the contents of the drum 644 during operation of the preheating assembly 220. In some embodiments, electrical power connections and/or other components associated with the heater 655 can be stored in the enclosure 537, which can be mounted to the exterior side of the front panel 641. The enclosure 537 can include a hole 637 for wires and/or other electrical connections to extend toward a power source, a controller, etc. In some embodiments, the enclosure 537 includes vent holes.

FIG. 6C is a rear view of the preheating assembly 220 with the rear panel 642 of the housing 532 removed for illustrative purposes. In the illustrated embodiment, the partition 656, the drum 644, and the baffle 646 divide the interior of the housing 532 into a first chamber 602 (e.g., the right half) and a second chamber 604 (e.g., the left half). In operation, the air mover 657 draws, a first airflow 606 from the drum 644 and past the heater 655 as it flows through the first chamber 602 toward the inlet shroud 658. The heated air is then drawn into the air mover 657 via the inlet shroud 658 and directed out of the air mover 657 as a second airflow 608 that flows upwardly toward the drum 644 via an elongate, longitudinal opening 659 between the partition 656 and the baffle 646. As noted above, the drum 644 is perforated so that the heated second airflow 608 flows through the drum 644 and back out as the first airflow 606, thereby forming a continuous loop of heated air that circulates through the housing 532 and through the drum 644 to heat the corn kernels therein.

FIG. 7A is a top isometric view of the preheating assembly 220 with the drum 644 and a top panel and a side panel of the housing 532 removed for illustrative purposes. The first shaft 536 is rotatably supported on either end by a bearing or other structure (e.g., by the bearing 542 at the proximal end portion thereof) and operably coupled to the first transmission 541 (not shown in FIG. 7A) housed in the first transmission enclosure 540. The preheating assembly 220 further includes a moving device, e.g., a helical auger 748 coaxially mounted to the first shaft 536. The auger 748 can extend along the length of the first shaft 536 within the drum 644 (not shown in FIG. 7A). In some embodiments, the drum 644 can be attached to the outer edges of the auger 748 or otherwise attached to the auger 748 and configured to rotate therewith. For example, in some embodiments the drum 644 can be formed from two halves (e.g., two half-cylinders) that can be wrapped around the auger 748 and stitch welded to one another and to the outer periphery of auger 748. Accordingly, in some embodiments, the drum 644 rotates with the first shaft 536 and the auger 748. Certain features of the preheating assembly 220 can be similar to corresponding features of the machines disclosed in U.S. Pat. No. 8,201,492, the disclosure of which is incorporated herein by reference in its entirety. In the illustrated embodiment, the auger 748 includes a first portion or segment 749a with blades at a first pitch and a second portion or segment 749b with blades at a second pitch different from the first pitch. Specifically, the blades in the first segment 749a are positioned closer to one another than the blades in the second segment 749b. In other embodiments, however, the auger 748 can include a different number of blade segments, a different pattern of blade pitches, or not have any pitch variation along the length of the first shaft 536.

FIG. 7B is a rear isometric view of portions of the drum 644 and the auger 748. In the illustrated embodiment, the drum 644 is perforated so that the second airflow 608 can flow into the drum 644 and the first airflow 606 can flow out of the drum 644. The perforation size can be selected (e.g., to be small enough) to prevent corn kernels 702 from falling through the walls of the drum 644 during operation of the auger 748. In some embodiments, the perforated drum 644 is 20-55% or 30-45% open, such as about 35% or about 42% open (e.g., 0.045″ round by 0.066″ centers).

Referring to FIGS. 5A-7B together, in operation, as the corn kernels 702 enter the drum 644 via the inlet 534, an operator can provide manual inputs via the controller 560 (FIG. 5A) to turn the preheating assembly 220 on and (i) activate the first motor 538 to rotate the auger 748, (ii) activate the second motor 550 to rotate the air mover 657, and (iii) activate the heater 655. Rotation of the air mover 657 moves air, heated by the heater 655, through the first chamber 602, the drum 644, and the second chamber 604 (FIG. 6C). Heat from the second airflow 608 is transferred to the corn kernels 702, thereby preheating the corn kernels 702. The air exits the drum 644 as the first airflow 606, thereby creating a continuous preheating cycle. Rotation of the auger 748 drives the corn kernels from the inlet 534, through the interior of the drum 644, out of the drum 644 and into the outlet chute 562 (see FIG. 5B), and out of the outlet chute 562 (e.g., to the popper 240). As described further herein, the rotation speed of the auger 748 can be controlled to achieve a desired ingredient flow rate through, and thus a desired residence time in, the drum 644, and the rotational speed of the air mover 657 and the power output of the heater 655 can be controlled to achieve a desired preheating rate of the corn kernels 702. For example, the ingredient flow rate and the temperature can be controlled to preheat the corn kernels 702 without drying them out or popping them. Advantageously, preheating corn kernels with hot air, as opposed to in, for example, oil, can more uniformly, or at least substantially uniformly, heat corn kernels to their core.

While FIGS. 5A-7B illustrate embodiments of a preheating assembly that can be used in popcorn making system in accordance with embodiments described herein, it will be understood that ingredients (e.g., corn kernels) can be used with other preheating assemblies without departing from the present disclosure. Accordingly, the various embodiments of the popcorn making systems described herein are not limited to include any particular type of preheating assembly unless the context expressly requires otherwise. For example, although FIGS. 5A-7B illustrate embodiments of a preheating assembly in which an auger moves corn kernels through a drum heated by hot airflow, the illustrated embodiment is merely one example of how corn kernels can be preheated. Other embodiments of preheating assemblies can include a heated ramp along which corn kernels can slide down, a kettle with rotating blades, etc.

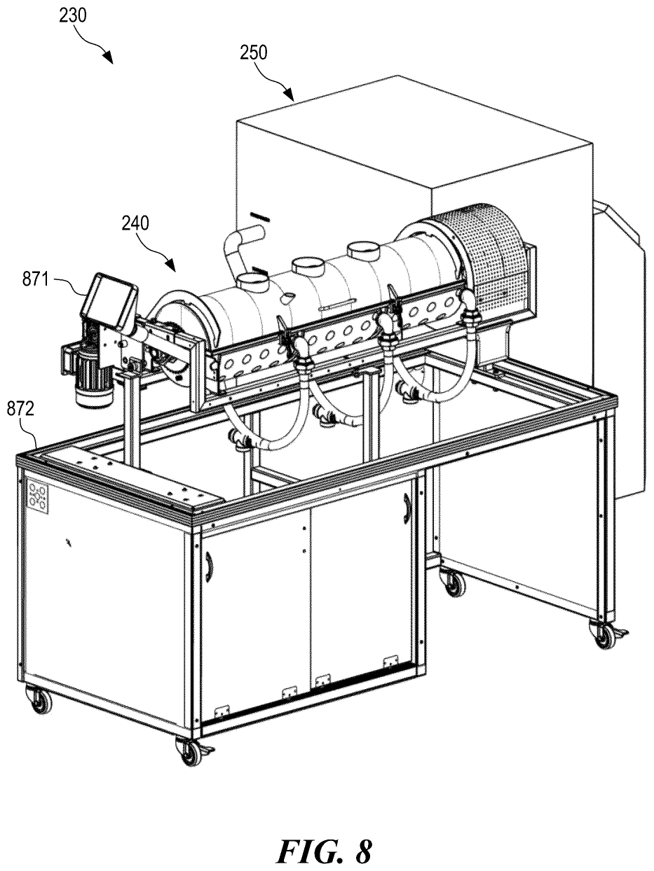

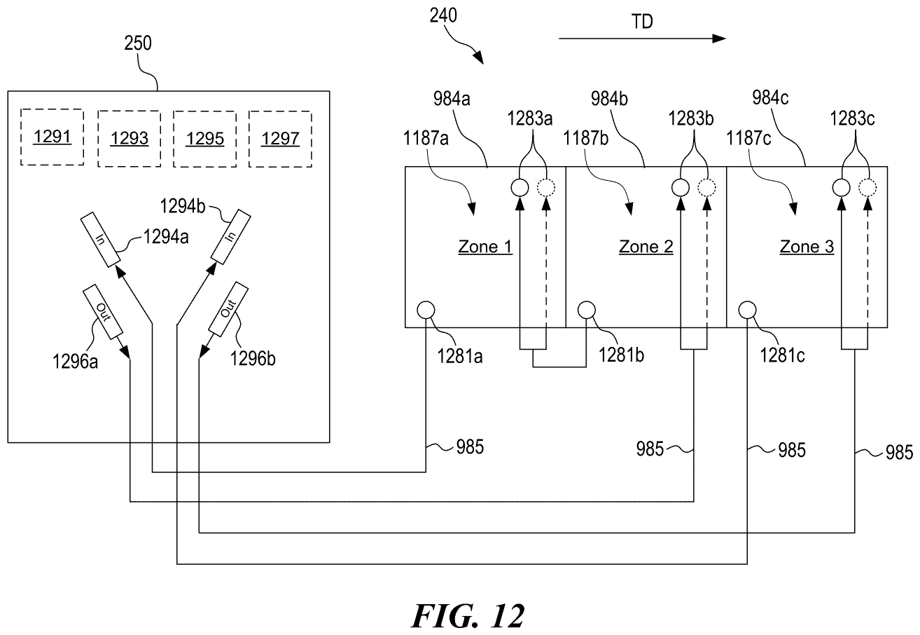

FIG. 8 is a front isometric view of the popping assembly 230, including the popper 240 and the popper heating unit 250. The popper 240 can be supported on a base structure 872 housing various electrical components, pipes, tubes, etc. for supporting operation of the popper 240. The popper 240 can include a funnel 871 defining an inlet through which preheated corn kernels (e.g., from the preheating assembly 220) can enter the popper 240. As described in further detail below with reference to FIG. 12, the popper heating unit 250 can be operated to provide heat to the popper 240 for popping corn kernels traveling through the popper 240. Examples of the popper 874 are disclosed in U.S. patent application Ser. No. 18/988,567, filed Dec. 19, 2024, the disclosure of which is incorporated herein by reference in its entirety.

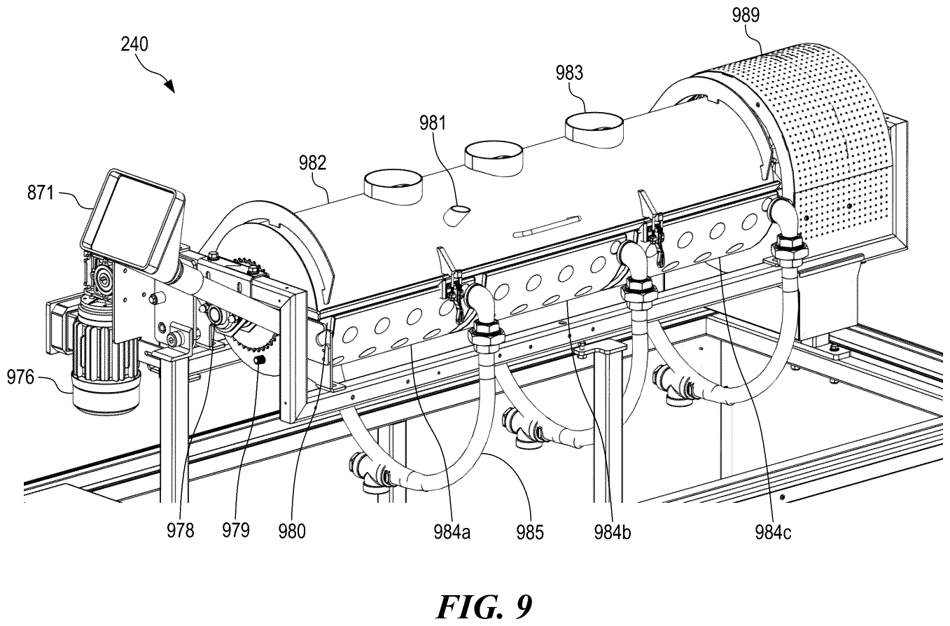

FIG. 9 is an enlarged isometric view of the popper 240. The popper 240 can include a trough 980, a cover 982 disposed thereon, a motor 976, a shaft 978, and a sifter 989. In the illustrated embodiment, each of the trough 980 and the cover 982 has a half-cylindrical shape so that the trough 980 and the cover 982 define a cylindrical internal chamber through which ingredients can flow. The cover 982 can be pivotably coupled to the trough 980 so that an operator can lift the cover 982 to access the interior chamber. The cover 982 can include one or more vents 983 for releasing excess heat, gas, etc. and a port 981 through which additional ingredients or additives (e.g., sugar, caramel, syrup) can be added for flavored popcorn or other food products. In some embodiments, the popper 240 includes multiple ports 981. In some embodiments, the port 981 is slidable (e.g., on a rail) along the length of the cover 982 so that additional ingredients or additives can be added at different stages of the popping process to, e.g., accommodate different recipes. Proximal to the trough 980 and the cover 982, the funnel 871 can be in fluid communication with the interior chamber. The trough 980 can also include a port 979 for receiving, for example, cooking oil (e.g., sunflower oil) in which the preheated corn kernels can be popped and which can add flavor to the resulting popcorn. Distal to the trough 980 and the cover 982, the sifter 989 can receive and sift the popped popcorn (or other food products). The motor 976 can be operably coupled to rotate the shaft 978 within the interior chamber.

The popper 240 additionally includes one or more heating units (individually labeled 984a, 984b, 984c; collectively referred to as “the heating units 984”). The heating units 984 are coupled to an outer surface and along the length of the trough 980. Each of the heating units 984 can be scaled (e.g., welded) to the trough 980 to define a corresponding fluid chamber therebetween. The heating units 984 can be coupled to the popper heating unit 250 (FIG. 8) via one or more tubes or pipes 985. As discussed further below, individual ones of the fluid chambers defined by the trough 980 and the heating units 984 can receive a continuous flow of a heat transfer fluid (e.g., oil, steam) from the popper heating unit 250. Depending on the temperature and flow rate of the heat transfer fluid therein, the internal chambers of the heating units 984 can define distinct heating zones with respective heating profiles for popping the corn kernels flowing within the internal chamber between the trough 980 and the cover 982. The fluid chambers can be fluid-tight so that the heat transfer fluid from the popper heating unit 250 does not come into direct contact or mix with the cooking oil delivered to the internal chamber between the trough 980 and the cover 982 via the port 979.

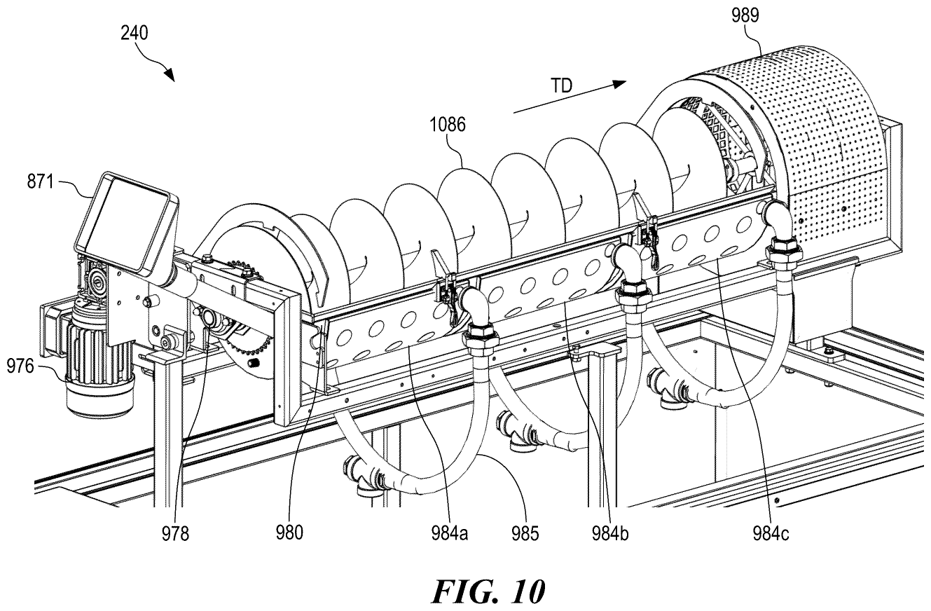

FIG. 10 is an enlarged isometric view of the popper 240 with the cover 982 removed for illustrative purposes. As shown, the popper 240 further includes a moving device, e.g., paddles and/or an auger 1086 coupled to the shaft 978 and extending along the length of the shaft 978 within the internal chamber between the trough 980 and the cover 982. The blade of the auger 1086 can have a constant pitch (as shown) or the auger 1086 can have multiple segments with blades at different pitches. In operation, the motor 976 can be controlled to rotate the shaft 978 and the auger 1086 to move the ingredients in a travel direction TD through the internal chamber at a desired speed. In some embodiments, the sifter 989 (or portions thereof) is also coupled to the shaft 978 so that the motor 976 can be controlled to rotate the sifter 989. In some embodiments, the trough 980 is angled so that the distal end of the trough 980 (e.g., interfacing the sifter 989) is higher than the proximal end of the trough 980 (e.g., interfacing the funnel 871). The angle of the trough 980 can be so that the pitch of the trough 980 is about 1/64 inch per foot, 1/32 inch per foot, 1/16 inch per foot, etc. Angling the trough 980 can prevent the cooking oil from exiting the popper 240 at the distal end of the trough 980 too rapidly. Angling the trough 980 can also help the cooking oil to pool, allowing the corn kernels to be better covered by (e.g., submerged in) the cooking oil and thereby properly pop.

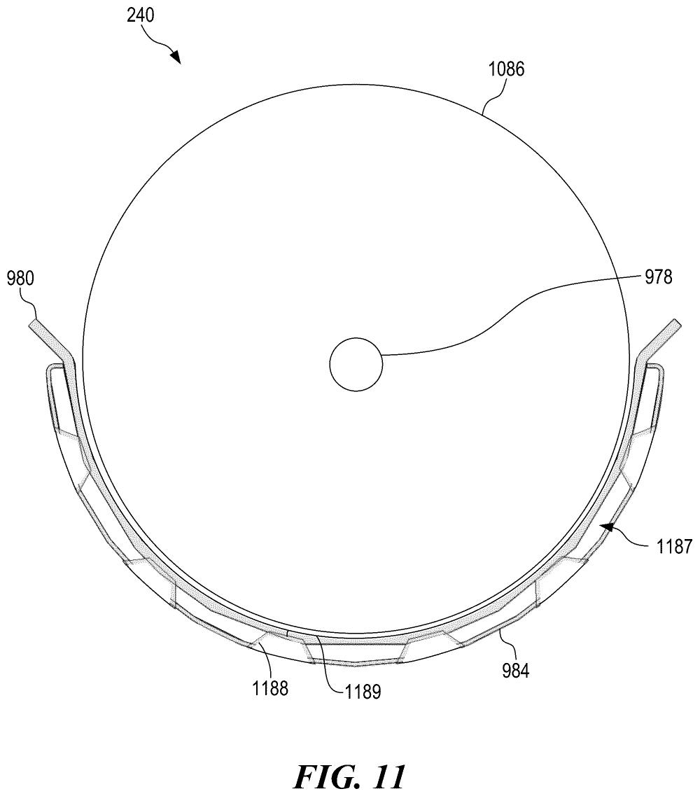

FIG. 11 is a front cross-sectional view of the popper 240. As shown, the heating unit 984 can be attached to the trough 980 (e.g., via welding) and form a fluid-tight seal to define a fluid chamber 1187 therebetween. It is appreciated that the illustrated heating unit 984 can be any of the individual heating units 984a, 984b, 984c illustrated in FIGS. 9 and 10. The heating unit 984 can additionally be coupled to the trough 980 via a plurality of recesses or dimples 1188 formed therein and having, e.g., frustoconical shapes. In the illustrated embodiment, the heating unit 984 is attached to the trough 980 by spotwelds 1189 positioned at the bottom of each dimple 1188. In other embodiments, the dimples 1188 can be coupled to the trough 980 via sealed fasteners, adhesives, or other coupling mechanisms. In the illustrated embodiment, the dimples 1188 are formed in a grid-like pattern in the outer wall of each heating unit 984. For example, the dimples 1188 can be arranged in rows and columns and can be separated from adjacent dimples by 1 inch, 1.5 inch, 2 inches, or other distances.

FIG. 12 is a schematic diagram illustrating operation of the popper 240 and the popper heating unit 250 in accordance with embodiments of the present technology. The popper heating unit 250 can include a control panel 1291 (shown schematically) having a user interface, a control system 1293 (shown schematically), one or more fluid pumps 1295 (shown schematically), one or more fluid heating elements 1297 (e.g., a resistive heater, an atmospheric or gas-burning heater, an infrared heater, an inductive heater) (also shown schematically), one or more fluid inlets 1294a-b, and one or more fluid outlets 1296a-b. The control system 1293 can be operatively coupled to the one or more pumps 1295 and to the one or more heating elements 1297, and operated by an operator via the control panel 1291.

In some embodiments, the control system 1293 can include at least one processor (e.g., a CPU(s), GPU(s), PLC(s), etc.), at least one non-transitory computer readable medium, e.g., memory, that stores computer-executable instructions for execution by the processor, and at least one communication device. The processor can be a single processing unit or multiple processing units in a device or distributed across multiple devices. The processor can be coupled to other hardware devices, for example, with the use of a bus, such as a PCI bus or SCSI bus. The processor can communicate with a hardware controller for devices, such as for the user interface of the control panel 1291. The user interface of the control panel 1291 can be used to display text and graphics via a display and/or receive control inputs via an input device. Examples of display devices are: an LCD display screen, an LED display screen, a projected, holographic, or augmented reality display (such as a heads-up display device or a head-mounted device), and so on. The communication device can be capable of communicating wirelessly or wire-based with a network node. The communication device can communicate with another device or a server through a network using, for example, TCP/IP protocols. The control system 1293 can utilize the communication device to distribute operations across multiple network devices.

The memory can include one or more hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. The memory is not a propagating signal divorced from underlying hardware; the memory is thus non-transitory. The memory can include program memory that stores programs and software. The memory can also include data memory, e.g., table data, column data, value filter data, user interface data, database element data, selection data, root table data, code snippet data, join query data, query template data, connection data, configuration data, settings, user options or preferences, etc., which can be provided to the program memory or any element of the control system 1293. Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, distributed computing environments that include any of the above systems or devices, or the like.

Each of the one or more fluid outlets 1296a-b can be coupled to deliver the heat transfer fluid to one or more of inlets (individually labeled 1283a, 1283b, 1283c; collectively referred to as “the inlets 1283”) of the heating units 984 via the pipes 985. The heat transfer fluid can then flow from the inlets 1283, through the fluid chambers (individually labeled 1187a, 1187b, 1187c; collectively referred to as “the fluid chambers 1187”), and out through corresponding outlets (individually labeled 1281a, 1281b, 1281c; collectively referred to as “the outlets 1281”) of the heating units 984. While flowing through the fluid chambers 1187, the heat transfer fluid can transfer its heat, through the trough 980, to the ingredients (e.g., preheated corn kernels, cooking oil) flowing in the internal chamber of the popper 240. The outlets 1281 can be coupled to deliver the cooled heat transfer fluid to the one or more fluid inlets 1294a-b of the popper heating unit 250 or to the inlets 1283 of a different heating unit 984 via the pipes 985. The cooled heat transfer fluid that returns to the popper heating unit 250 can then be re-heated by the one or more heating elements 1297, and pumped back to the heating units 984 by the one or more pumps 1295. Components of the control system 1293 (e.g., the memory) can store instructions that, when executed by the processor, cause the control system 1293 to operate the one or more pumps 1295 and the one or more heating elements 1297 to control flow and temperatures, respectively, of the heat transfer fluid pumped into and out of the heating units 984.

Because the heating units 984 are arranged along the length of the trough 980 and the fluid chambers 1187 are isolated from one another, each heating unit 984 can define a zone (e.g., Zone 1, Zone 2, and Zone 3) that can be independently heated to, e.g., different temperatures by providing heat transfer fluid of different temperature profiles to the different heating units 984. In some embodiments, however, two or more of the heating units 984 can be fluidly coupled so that two or more zones provide the same heating profile.

For example, in FIG. 12, the inlets 1283b of the second heating unit 984b are coupled to receive heated fluid from the fluid outlet 1296a of the popper heating unit 250, the outlet 1281b of the second heating unit 984b is coupled to the inlets 1283a of the first heating unit 984a, and the outlets 1281a of the first heating unit 984a is coupled to the fluid inlet 1294a of the popper heating unit 250. Also, the inlets 1283c of the third heating unit 984c are coupled to receive heated fluid from the fluid outlet 1296b of the popper heating unit 250, and the outlet 1281c of the third heating unit 984c is coupled to the fluid inlet 1294b of the popper heating unit 250. As a result, in the illustrated embodiment Zone 1 can be configured to provide a cooler (e.g., due to heat transfer occurring in the second heating unit 984b) and/or approximately the same heating profile, and at different positions along the length of the trough 980, and Zone 3 can provide the same or a different (e.g., lower, higher) heating profile. Also, notably, the heat transfer fluid travels in a direction opposite the travel direction TD of the ingredients. It is appreciated that the inlets 1283 and the outlets 1281 can be coupled to one another in different arrangements, or not coupled to one another, and/or to provide different heating profile arrangements along the length of the trough 980. Also, it is appreciated that in some embodiments, the inlets 1283 can be coupled to the fluid inlets 1294a-b and the outlets 1281 can be coupled to the fluid outlets 1296a-b so that the heat transfer fluid travels in the travel direction TD of the ingredients.

While FIGS. 8-12 illustrate embodiments of a “continuous” popcorn popper that can be used with the preheating assembly embodiments described herein, it will be understood that embodiments of the preheating assembly described herein can be used with other popcorn poppers without departing from the present disclosure. Accordingly, the various embodiments of preheating assemblies and the associated popcorn making systems described herein are not limited to use with any particular type of popcorn popper unless the context expressly requires otherwise. For example, although FIGS. 8-12 illustrate embodiments of a continuous popcorn popper in which a heat transfer fluid is pumped between the trough and heating units to heat and thereby pop the corn kernels, the illustrated embodiment is merely one example of how preheated corn kernels can be popped. The embodiments of the preheating assembly and the hybrid popping process described herein can be used with various types of heating and/or popping machines (e.g., oil poppers using resistive heaters), and are not limited to use with the popper 240 and the popper heating unit 250 illustrated and described herein. For example, one or more resistive, gas-burning, infrared, induction, and/or other heaters can be positioned to directly heat the trough 980 without the use of a heat transfer fluid, and can be used to define various heating zones and corresponding heating profiles in a manner similar to the popper 240 and the popper heating unit 250 as discussed above with reference to FIG. 12.

### III. Methods of Operating a Popcorn Making System

FIG. 13 is a flowchart illustrating a method 1300 for operating a popcorn making system (e.g., the popcorn making system 100 of FIG. 1, the popcorn making system 200 of FIG. 2) with a hybrid popping process in accordance with embodiments of the present technology. While the steps of the method 1300 are described below in a particular order, one or more of the steps can be performed in a different order or omitted, and the method 1300 can include additional and/or alternative steps. Additionally, although the method 1300 may be described below with reference to the embodiments of the present technology described herein, the method 1300 can be performed with other embodiments of the present technology.

The method 1300 begins at block 1302 by feeding corn kernels to a preheating assembly (e.g., the preheating assembly 220). In some embodiments, the corn kernels are fed to the preheating assembly by a feed assembly (e.g., the feed assembly 210). In some embodiments, the corn kernels are fed to the preheating assembly at a feed rate. The feed rate can be controlled by, for example, controlling the motor 312 to rotate the helical member 426 (FIG. 4) at a certain rotational speed to achieve a desired feed rate. In some embodiments, the feed rate of corn kernels can be between 10-2,000 lbs/hr, 20-1,000 lbs/hr, 25-500 lbs/hr, 30-200 lbs/hr, 40-100 lbs/hr, about 53 lbs/hr, etc.

At block 1304, the method 1300 continues by moving the corn kernels through the preheating assembly (e.g., the preheating assembly 220) and preheating the corn kernels to a preheating temperature. In some embodiments, the corn kernels can be moved through a heated drum (e.g., the drum 644) by a moving device (e.g., the auger 748) positioned within the drum. The movement of the corn kernels can be controlled by, for example, controlling the first motor 538 to rotate the auger 748 at a selected speed. In some embodiments, the rotational speed of the auger can be between 10-40 RPM, between 20-30 RPM, or about 22 RPM. In some embodiments, the rotational speed is set so that the corn kernels move through the preheating assembly for the duration of a first residence time between 10-50 seconds, between 20-40 seconds, or about 24 seconds. The residence time can be selected to heat the corn kernels uniformly to their cores without, or at least substantially without, losing moisture, drying out, and/or popping.

In some embodiments, the corn kernels are preheated in the preheating assembly using an air mover (e.g., the air mover 657) and a heater (e.g., the heater 655). The preheating temperature can be controlled by, for example, controlling the second motor 550 to rotate the air mover at a selected rotational speed and controlling the heater to operate at a selected temperature level. In some embodiments, the air mover includes a fan that is rotated at speed between 600-1,200 RPM, between 700-1,000 RPM, or about 800 RPM. The rotational speed can be selected to achieve a drum heating temperature sufficient cause corn kernel fluidization, which can improve uniform preheating of the corn kernels. The degree of corn kernel fluidization can be inspected visually and/or via temperature sensors, and the rotational speed of the air mover can be adjusted accordingly. In some embodiments, the preheating temperature is set to a temperature between 400-500° F., between 410° F.-480° F., between 420° F.-460° F., about 424° F. or about 435° F. In some embodiments, the preheating parameters are optimized based on temperature and/or moisture content measurements of corn kernels (e.g., select samples of the corn kernels can be taken for moisture content measurements as a proxy for the moisture content of the remaining corn kernels). The temperature and moisture content measurements may correlate. The moisture content measurements can verify uniform preheating of the corn kernels.

At block 1306, the method 1300 continues by feeding the preheated corn kernels to a popping assembly (e.g., the popping assembly 230). In some embodiments, the preheated corn kernels can be fed from the preheating assembly to the popping assembly via one or more chutes (e.g., the outlet chute 562, the funnel 871).

At block 1308, the method 1300 continues by adding cooking oil to the popping assembly. For example, the cooking oil can be added to the popping assembly via a port (e.g., the port 979) in a trough of the popping assembly. In some embodiments, the cooking oil is added at a selected delivery rate. The cooking oil delivery rate can be between 3-700 lbs/hr, 5-300 lbs/hr, 10-100 lbs/hr, 15-50 lbs/hr, about 17.7 lbs/hr, etc. The cooking oil delivery rate can be set based on the feed rate of the corn kernels. For example, the ratio between the feed rate of the corn kernels and the cooking oil delivery rate can be set to between 1:1-7:1, such as 3:1. In some embodiments, the cooking oil is added to the popping assembly at an initial temperature between 150-300° F., such as 220° F. (e.g., via operation of the oil preheating assembly 122 of FIG. 1).

At block 1310, the method 1300 continues by moving the preheated corn kernels and the cooking oil through the popping assembly and heating the preheated corn kernels to a popping temperature to pop the corn kernels. For example, the motor 976 can be controlled to rotate a moving device (e.g., the auger 1086 of FIG. 10) at a selected rotational speed of between 3-15 RPM, between 5-10 RPM, or about 7 RPM. In some embodiments, the rotational speed is selected so that the corn kernels move through the popping assembly for the duration of a second residence time between 50-100 seconds, between 20-80 seconds, or about 71 seconds. The residence time can be selected to reliably pop the corn kernels while maximizing popcorn output rate.

In some embodiments, a series of heating units (e.g., the heating units 984) are used to direct heat transfer fluids (e.g., oil, steam) against a trough (e.g., the trough 980) to transfer heat to the preheated corn kernels and the cooking oil. For example, in some embodiments three such heating units can be arranged along the length of the trough to define Zone 1, Zone 2, and Zone 3, as discussed above with reference to FIG. 12. In some embodiments, Zones 1 and 2 are set to have the heat transfer fluid therethrough at a first temperature value between 400-600° F., such as 425° F. or 470° F., and Zone 3 is set to have the heat transfer fluid therethrough at a second temperature value between 400-600° F., such as 470° F. It is appreciated that a different number of zones and/or a different combination of temperature profiles can be used to heat and thereby pop the corn kernels in the popping assembly. Moreover, it will be understood that the popping assemblies and associated popcorn poppers described herein are suitable examples of popcorn popping assemblies that can be used to pop preheated corn kernels in accordance with the present technology, but other popcorn popping assemblies can also be used to pop preheated corn kernels in accordance with the present technology.

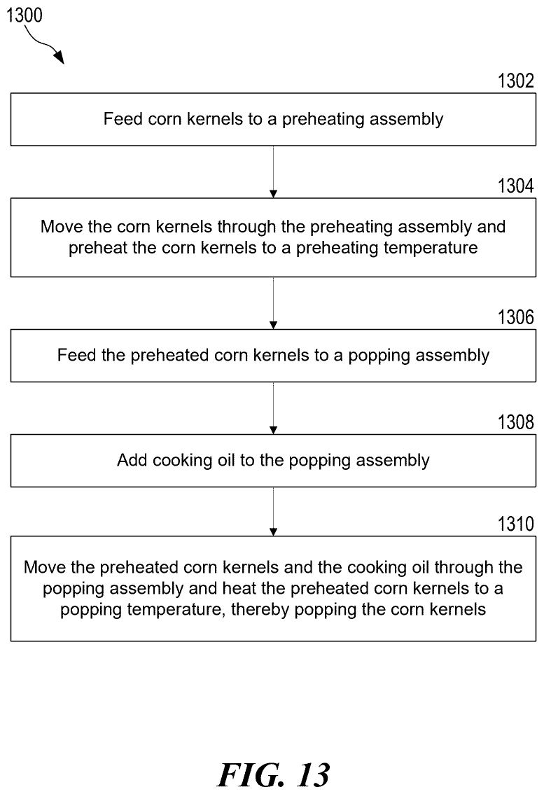

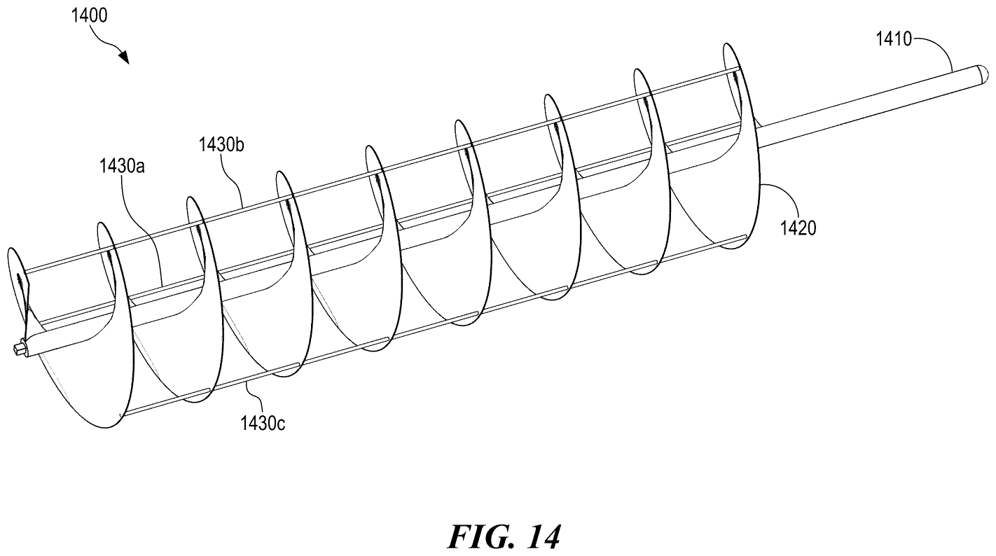

FIG. 14 is an isometric view of an auger assembly 1400 configured in accordance with embodiments of the present technology. The auger assembly 1400 can include a shaft 1410, an auger 1420 (e.g., a helical auger), and one or more agitators (individually labeled 1430a-1430c, collectively referred to as “the agitators 1430”). The auger assembly 1400 can be used with and/or in place of other apparatuses disclosed herein. For example, the shaft 1410 can be an example of the shaft 978 (FIGS. 9-11), the auger 1420 can be an example of the auger 1086 (FIGS. 10-11), and the auger assembly 1400 can be used with the trough 980, the cover 982, the motor 976, the sifter 989, and/or the like as part of the popper 240.

The auger 1420 can be coupled (e.g., welded) around and along at least a portion of the length of the shaft 1410. In the illustrated embodiment, the auger 1420 does not extend the entire length of the shaft 1410. Thus, a sifter (e.g., the sifter 989) can be coupled to the remaining portion of the length of the shaft 1410.

The agitators 1430 can include one or more wires or rods (e.g., metal such as stainless steel) that extend through and/or in between flights of the auger 1420. For example, the first agitator 1430a can include a single wire extending along the entire length of the auger 1420 or a plurality of wire segments aligned along the length of the auger 1420. The agitators 1430 can be coupled to the auger 1420 via welding, fasteners (e.g., bolts), and/or other suitable attachment mechanisms. Moreover, each of the agitators 1430 can be coupled at or near the peripheral edge of auger 1420. Therefore, in operation, the agitators 1430 can move close to the trough (e.g., the trough 980) as the shaft 1410 and the auger 1420 rotate, and thereby agitate the corn kernels, the oil, seasonings (e.g., sugar), and/or other ingredients in the popper (e.g., the popper 240). Such agitation can improve mixing, and thus proper cooking, of the ingredients.

The auger assembly 1400 of FIG. 14 is merely an illustrative example, and other embodiments of the present technology can include fewer, additional, and/or alternative components. For example, while the illustrated auger assembly 1400 includes a total of three agitators 1430, fewer or additional agitators 1430 (e.g., one, two, four, five, or more) can be included. The agitators 1430 can be distributed around the helical circumference of the auger 1420 at a constant angle (e.g., at 90 degrees for four agitators 1430) or varying angles. As another example, while the illustrated agitators 1430 extend along the entire length of the auger 1420, the agitators 1410 may not extend so and/or may include gaps between certain adjacent flights of the auger 1420.

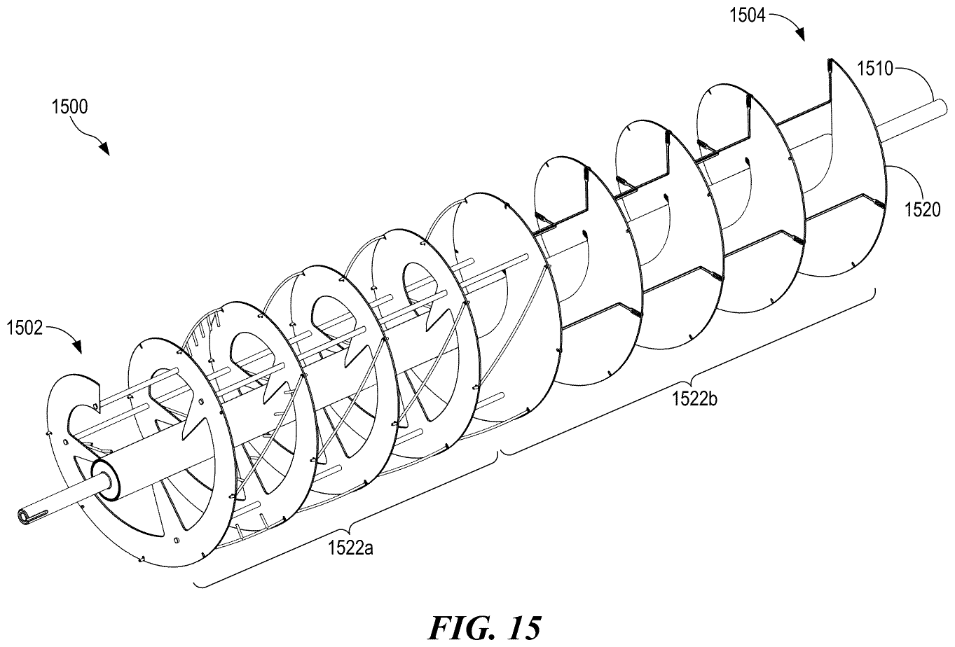

FIG. 15 is an isometric view of another auger assembly 1500 configured in accordance with embodiments of the present technology. The auger assembly 1500 can include a shaft 1510 and an auger 1520 (e.g., a helical auger). As discussed further herein, the auger assembly 1500 can also include various features such as support rods, agitators, and/or sifting rods. While the illustrated auger assembly 1500 includes a combination of these various features, such features may be independent of one another, and may or may not be included in some embodiments.

The shaft 1510 extends between a front end portion 1502 and a rear end portion 1504 of the auger assembly 1500. The auger 1520 can be coupled (e.g., welded) around and along at least a portion of the length of the shaft 1510. A sifter (e.g., the sifter 989) can be coupled to the remaining portion of the length of the shaft 1510. In the illustrated embodiment, the auger 1520 includes (i) a ribbon flighting zone 1522a extending from the front end portion 1502 and (ii) a full flighting zone 1522b extending between the ribbon flighting zone 1522a and near the rear end portion 1504.

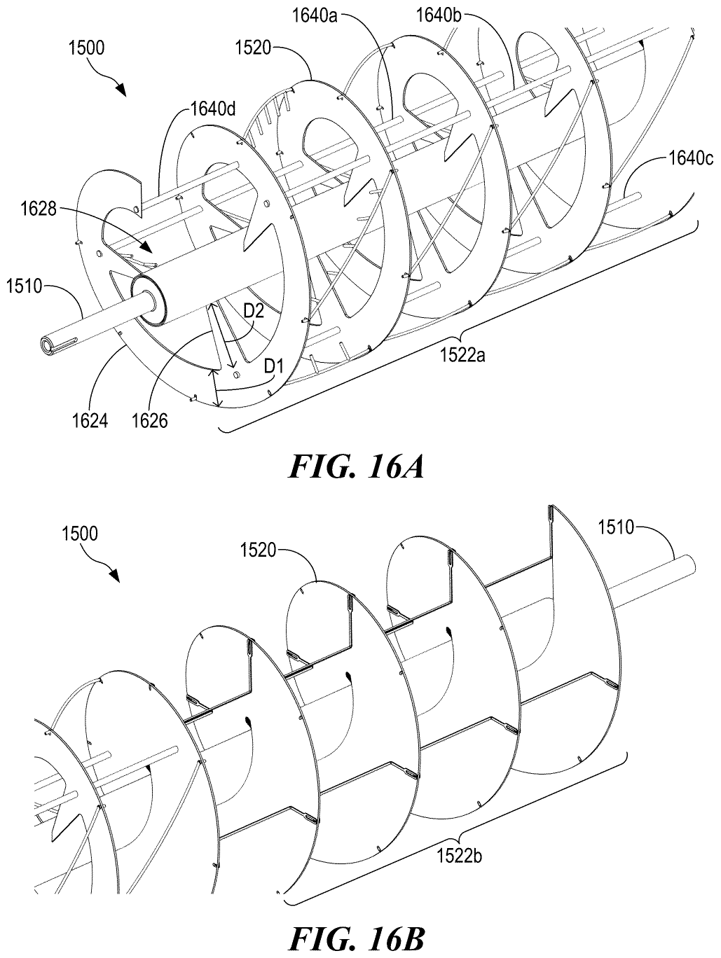

FIGS. 16A and 16B are enlarged perspective views of the ribbon flighting zone 1522a and the full flighting zone 1522b, respectively, of the auger 1520. Referring first to FIG. 16A, the auger 1520 at the ribbon flighting zone 1522a includes a ribbon portion 1624 and a plurality of connectors 1626. The ribbon portion 1624 can include a ribbon or strip of the auger material (e.g., metal such as stainless steel) extending around and along a portion of the length of the shaft 1510. In particular, the ribbon portion 1624 can remain spaced apart from the shaft 1510, and the connectors 1626 can extend between parts of the ribbon portion 1624 and the shaft 1510 to thereby support the ribbon portion 1624. The ribbon portion 1624 can contact and thereby mix the ingredients in the popper 240. While FIG. 16A illustrates three connectors 1626 per flight (e.g., separated by 120 degrees), there can be fewer or more connectors 1626 per flight.

The auger assembly 1500 can further include one or more support rods (individually labeled 1640a-1640d, collectively referred to as “the support rods 1640”). In the illustrated embodiment, first through third support rods 1640a-1640c extend through the ribbon portion 1624 and are aligned with the connectors 1626. In other embodiments, however, the first through third support rods 1640a-1640c need not be aligned with the connectors 1626. Alternatively, the first through third support rods 1640a-1640c may extend through the connectors 1626. The fourth support rod 1640 can extend between the beginning of the ribbon portion 1624 and the next flight to provide additional support to the otherwise cantilevered tip of the ribbon portion 1624. In other embodiments, a different number of support rods 1640 can be included.

The ribbon portion 1624 and the connectors 1626 can define gaps or openings 1628 in the auger 1520. Thus, in operation, the ribbon flighting zone 1522a can provide increased visualization of the cooking process. For example, the cover 982 of FIG. 9 can include one or more viewing ports (e.g., spaced apart from one another by three feet) that an operator can look through to see the inside of the popper 240 (e.g., to verify that the ingredients are mixing properly and sufficiently), and the openings 1628 can allow the operator to view a larger portion of the interior of the popper 240. The ribbon portion 1624 can have a radial length D1, each connector 1626 can have a radial length D2, and the ratio D1:D2 can be between 0.1:1-2:1 (e.g., about 0.5:1, 1:1). The ratio can be selected to ensure that the performance of the auger 1520 at the ribbon flighting zone 1522a is not compromised while still providing the increased visualization.

Referring next to FIG. 16B, the auger 1520 at the full flighting zone 1522b can be a conventional auger that is fully coupled to the shaft 1510 and does not include openings. Because mixing of the ingredients (e.g., corn kernels and oil) is expected to primarily occur near the front end portion 1502 of the auger assembly 1500, visualization to ensure proper mixing can be particularly important near the front end portion 1502. Therefore, the auger 1520 may not need openings towards the rear end portion 1504. In some embodiments, the ratio between the length of the ribbon flighting zone 1522a and the full flighting zone 1522b is between 0.5:1-2:1 (e.g., about 1:1).

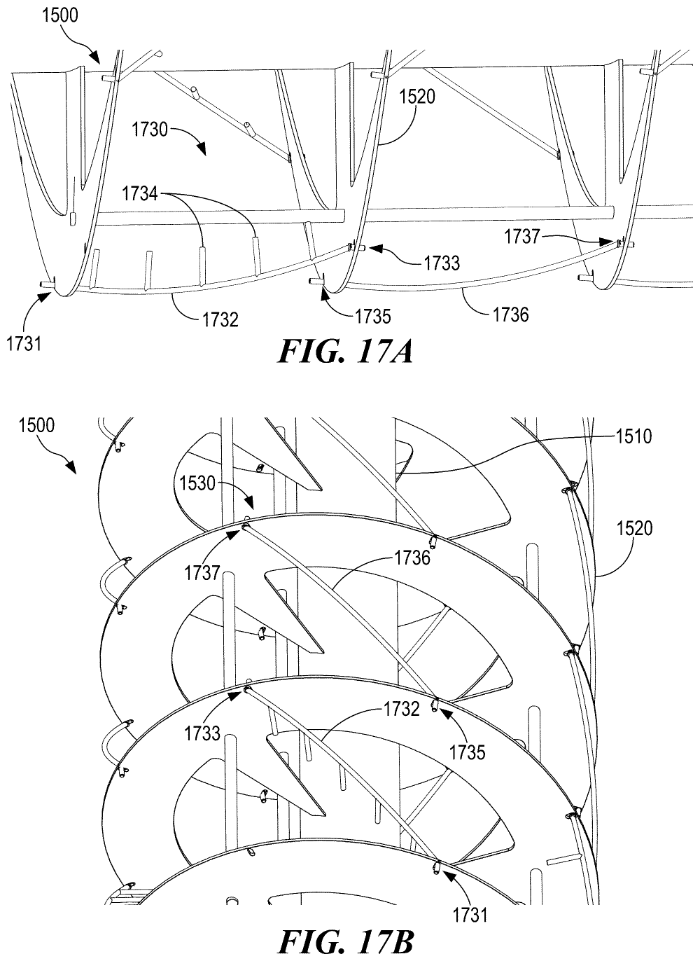

FIGS. 17A and 17B are enlarged side and top views, respectively, of agitators 1730 included in the auger assembly 1500 and configured in accordance with embodiments of the present technology. Referring first to FIG. 17A, the agitators 1730 can include a first agitator wire 1732 and a second agitator wire 1736. The first agitator wire 1732 can extend between a first connection point 1731 on a first flight and a second connection point 1733 on a second flight. The second agitator wire 1736 can extend between a third connection point 1735 on the second flight and a fourth connection point 1737 on a third flight. In the illustrated embodiment, the first agitator wire 1732 and the second agitator wire 1736 can differ in that one or more protrusions 1734 can extend radially inward (e.g., generally toward the shaft 1510) from the first agitator wire 1732, but not from the second agitator wire 1736. The number of agitators 1730 per cycle can be one, two, three, or more (e.g., circumferentially distributed around the auger 1520).

Referring next to FIG. 17B, as shown, the first connection point 1731 and the second connection point 1733 are at different radial angles relative to the shaft 1510, and the third connection point 1735 and the fourth connection point 1737 are also at different radial angles relative to the shaft 1510. Accordingly, each of the first agitator wire 1732 and the second agitator wire 1736 extends at least partially rotationally around the shaft 1510. As also shown in FIG. 17B, the first connection point 1731 and the third connection point 1735 are generally at the same angular position (e.g., aligned) relative to the shaft 1510, while the second connection point 1733 and the fourth connection point 1737 are generally at the same angular position (e.g., aligned) relative to the shaft 1510.

Referring to FIGS. 17A and 17B together, each of the connection points 1731, 1733, 1735, 1737 can be at or near the periphery of the auger 1520, and each of the first agitator wire 1732 and the second agitator wire 1736 can have a curvature corresponding to the trough 980. Accordingly, as the auger 1520 rotates, each of the first agitator wire 1732 and the second agitator wire 1736 can move adjacent to the trough 980 and thereby contact and mix the ingredients. The protrusions 1734 extending from the first agitator wire 1732 can increase the level of agitation and mixing of the ingredients.

It is appreciated that while FIGS. 17A and 17B illustrate the first agitator wire 1732 (with the protrusions 1734) followed immediately by the second agitator wire 1736 (with no protrusions), the arrangement of the first agitator wire 1732 and the second agitator wire 1736 can vary. For example, in some embodiments, the auger assembly 1500 includes an alternating pattern of first agitator wires 1732 and second agitator wires 1736 along the length of the auger 1520. In some embodiments, the auger assembly 1500 includes only the first agitator wires 1732 or only the second agitator wires 1736.

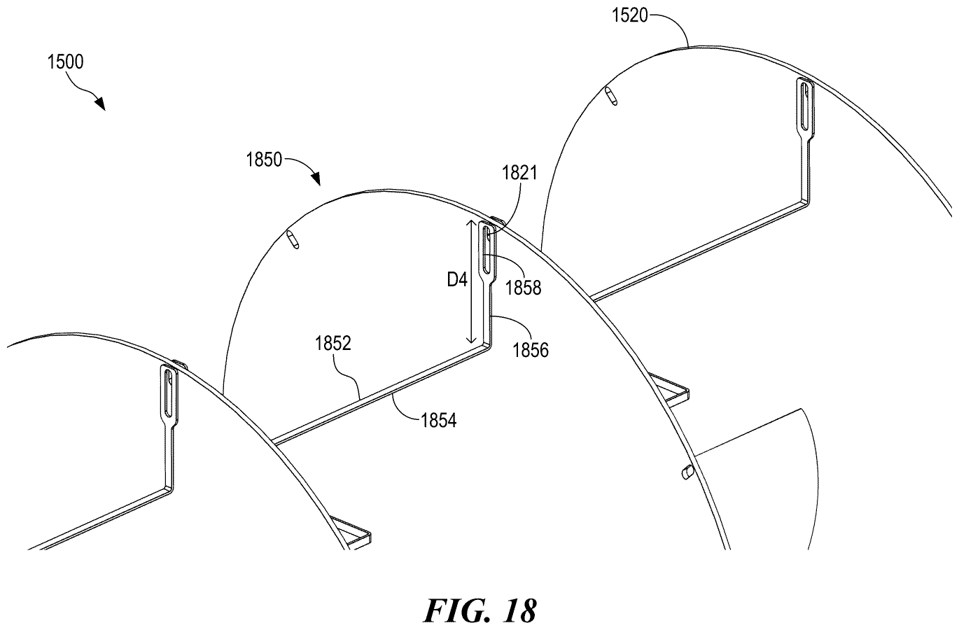

FIG. 18 is an enlarged perspective view of sifter rods 1850 included in the auger assembly 1500 and configured in accordance with embodiments of the present technology. Each sifter rod 1850 can include a strip of wire (or other component) having (i) a longitudinal portion 1854 extending between adjacent flights of the auger 1520 and (ii) two vertical portions 1856 (only one is shown and the other of each sifter rod 1850 is obscured from view) extending generally at a right angle from the two ends of the longitudinal portion 1854. The vertical portions 1856 can be welded, fastened, or otherwise coupled to the auger 1520. For example, in the illustrated embodiment, each flight of the auger 1520 at the full flighting zone 1522b includes an aperture 1821 near the periphery thereof, and each vertical portion 1856 can include an aperture 1858 so that a fastener can extend through both apertures 1821, 1858 to secure the sifter rods 1850 to the auger 1520.

As shown, the longitudinal portion 1854 can be spaced apart from the periphery of the auger 1520, and thus spaced apart from the inner surface of the trough 980, by a distance D4. The distance D4 can selected such that the longitudinal portion 1854 can sift through the food products and allow any uncooked ingredients (e.g., un-popped corn kernels) that remain to drop onto the trough 980 and become cooked. Accordingly, the sifter rods 1850 are expected to provide scrap reduction.

In some embodiments, the agitators 1730 are generally positioned in the ribbon flighting zone 1522a while the sifter rods 1850 are generally positioned in the full flighting zone 1522b of the auger 1520. Accordingly, the agitators 1730 can agitate and mix the ingredients in, for example, the first half of the popper 240 where mixing is particularly important, and the sifter rods 1850 provide scrap reduction in, for example, the second half of the popper 240 once the majority of the ingredients (e.g., corn kernels) have been cooked properly.

Embodiments of the popping processes described herein of preheating corn kernels using, e.g., hot air and then popping the preheated corn in, e.g., cooking oil can advantageously provide relatively high levels of popcorn production as compared to existing popcorn popping processes. For example, compared to using an oil batch popper to both heat and pop corn kernels (without preheating the kernels), the popcorn making systems described herein can produce the same amount of popcorn in less time (e.g., approximately 30-50% less time). In particular, because the cooking oil is used only or primarily for popping, as opposed to heating, the corn kernels, the cooking oil and the preheated corn kernels can be moved through the popcorn popper at a faster rate (e.g., by a factor of 3) to reduce the residence time in the popper accordingly. Moreover, for the same reason, the popper 240 can be sized to be smaller in, e.g., length and/or diameter than if the popper 240 were to be used for both heating and popping the corn kernels. In some embodiments, reducing the residence time of the cooking oil being heated (e.g., in the popper 240 by the popper heating unit 250) can eliminate or at least reduce the risk of the cooking oil oxidizing or otherwise degrading.

In addition to the increased production rate, embodiments of the popcorn making systems described herein can also produce popcorn with properties similar or superior to popcorn produced by existing popcorn machines. For example, in some embodiments the popcorn making systems described herein can produce popcorn with a bulk density of, e.g., 1.8 lbs/ft³-2.0 lbs/ft³, or about 1.94 lbs/ft³, and with a scrap rate less than 5%, less than 4%, or about 3.6%. Also, embodiments of the popcorn making systems described herein can produce popcorn at a production rate similar to conventional air poppers while additionally offering the benefits that come with cooking popcorn in oil (e.g., improved popcorn flavor). Moreover, embodiments of the preheating process described above results in little to no moisture loss from the corn kernels, which can be important to ensure that the corn kernels subsequently pop reliably.

As used herein, the use of relative terminology, such as “about”, “generally”, “approximately”, “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

### IV. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. A popcorn making system, comprising:
a corn kernels preheating assembly configured to preheat corn kernels in a first medium without popping the corn kernels; and
a popping assembly positioned downstream of the corn kernels preheating assembly, wherein the popping assembly is configured to receive the preheated corn kernels from the corn kernels preheating assembly and further heat the preheated corn kernels in a second medium until the corn kernels pop,
wherein the second medium is different from the first medium.

2. The popcorn making system of example 1, wherein the first medium is in a gaseous phase, and wherein the second medium is in a liquid phase.

3. The popcorn making system of example 1 or example 2, wherein the first medium is air, and wherein the second medium is oil.

4. The popcorn making system of any of examples 1-3, wherein the corn kernels preheating assembly includes:
a perforated drum positioned to receive the corn kernels;
a first moving device disposed inside the drum and configured to move the corn kernels through the perforated drum;
an air mover positioned external to the perforated drum; and
a heater positioned external to the perforated drum, wherein the air mover and the heater are configured to preheat the corn kernels moving through the drum in the first medium.

5. The popcorn making system of any of examples 1-4, wherein the corn kernels preheating assembly is configured to preheat the corn kernels to a preheating temperature between 400-500° F.

6. The popcorn making system of any of examples 1-5, wherein the popping assembly is configured to heat the preheated corn kernels to a popping temperature between 400-600° F.

7. The popcorn making system of any of examples 1-6, wherein the corn kernels preheating assembly is configured to preheat the corn kernels to a preheating temperature, and wherein the popping assembly is configured to heat the preheated corn kernels to a popping temperature higher than the preheating temperature.

8. The popcorn making system of any of examples 1-7, further comprising at least one of:
an oil preheating assembly configured to preheat the second medium; or
a seasoning preheating assembly configured to preheat seasoning,
wherein the popping assembly is configured to receive at least one of (i) the preheated second medium from the oil preheating assembly or (ii) the preheated seasoning from the seasoning preheating assembly.

9. The popcorn making system of any of examples 1-8, further comprising at least one of:
a corn kernels feed assembly configured to provide the corn kernels to the corn kernels preheating assembly at a first desired rate;
an oil feed assembly configured to provide the second medium to the oil preheating assembly at a second desired rate; or
a seasoning feed assembly configured to provide the seasoning to the seasoning preheating assembly at a third desired rate.

10. A method of making popcorn, the method comprising:
preheating, via a preheating assembly, corn kernels in a first medium to a preheating temperature without popping the corn kernels;
transferring the preheated corn kernels from the preheating assembly to a popping assembly;
transferring a second medium to the popping assembly, wherein the second medium is different from the first medium;
moving the preheated corn kernels and the second medium through the popping assembly; and
heating, via the popping assembly, the preheated corn kernels in the second medium to a popping temperature, thereby popping the corn kernels.

11. The method of example 10, wherein preheating the corn kernels comprises preheating the corn kernels during a residence time between 10-50 seconds.

12. The method of example 10 or example 11, wherein moving the preheated corn kernels comprises moving the preheated corn kernels through the popping assembly during a residence time between 50-100 seconds.

13. The method of any of examples 10-12, wherein preheating the corn kernels comprises:
moving the corn kernels through a perforated drum of the preheating assembly; and
moving the first medium through and across the perforated drum such that the first medium contacts and thereby preheats the corn kernels to the preheating temperature.

14. The method of any of examples 10-13, wherein preheating the corn kernels comprises causing fluidization of the corn kernels and thereby improving uniform preheating of the corn kernels.

15. The method of any of examples 10-14, further comprising:
measuring a moisture content of a sample of the corn kernels; and
optimizing preheating parameters of the preheating assembly based on the measured moisture content.

16. The method of any of examples 10-15, wherein the first medium is air, and wherein the second medium is cooking oil.

17. The method of any of examples 10-16, wherein the preheating temperature is between 400-500° F., and wherein the popping temperature is between 400-600° F.

18. An auger assembly, comprising:
a shaft;
an auger coupled to and extending along at least a portion of a length of the shaft, wherein the auger includes a ribbon flighting zone, a full flighting zone, and a plurality of flights, wherein the auger includes a plurality of openings sized to provide visualization of spaces between the plurality of flights, wherein a ratio between a length of the ribbon flighting zone and a length of the full flighting zone is between 0.5:1-2:1; and
one or more agitators each including a wire coupled between peripheral edges of adjacent ones of the plurality of flights, wherein the agitators are configured to contact ingredients and thereby increase mixing of the ingredients.

19. The auger assembly of example 18, wherein the one or more agitators each further include a plurality of protrusions extending from the wire and generally toward the shaft.

20. The auger assembly of example 18 or example 19, wherein:
the auger is positionable adjacent to a trough, and
the wire of each of the one or more agitators (i) is coupled to the auger at a first connection point and a second connection point at a different circumferential angle relative to the shaft, and (ii) has a curvature corresponding to the trough.

21. A popcorn making system, comprising:
a preheating assembly configured to receive corn kernels and preheat the corn kernels; and
a popping assembly positioned downstream of the preheating assembly, wherein the popping assembly is configured to receive the preheated corn kernels and further heat the preheated corn kernels until the corn kernels pop.

22. The popcorn making system of example 21, further comprising a feed assembly configured to receive the corn kernels and output the corn kernels to the preheating assembly at a selected feed rate.

23. The popcorn making system of example 21 or example 22, wherein the wherein the preheating assembly includes:
a perforated drum positioned to receive the corn kernels;
a first moving device disposed inside the drum and configured to move the corn kernels through the drum;
an air mover positioned external to the drum; and
a heater positioned external to the drum, wherein the air mover and the heater are configured to preheat the corn kernels moving through the drum in air.

24. The popcorn making system of any one of examples 21-23, wherein the popping assembly includes:
a popper positioned to receive (i) the preheated corn kernels from the preheating assembly and (ii) cooking oil; and
one or more heating units configured to heat and thereby pop the preheated corn kernels in the cooking oil in the popper.

25. A method of operating a popcorn making system, the method comprising:
feeding corn kernels to a preheating assembly;
moving the corn kernels through the preheating assembly and in air;
preheating the corn kernels in the preheating assembly to a preheating temperature;
feeding the preheated corn kernels to a popping assembly;
adding cooking oil to the popping assembly;
moving the preheated corn kernels and the cooking oil through the popping assembly; and heating the preheated corn kernels to a popping temperature, thereby popping the corn kernels.

### V. CONCLUSION

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize. For example, although embodiments of the present technology are described below primarily in the context of preheating and popping corn kernels to produce popcorn, it will be appreciated that embodiments of the present technology can alternatively or additionally be used to produce or process other forms of food, such as to cook or pop other grains (e.g., sorghum, amaranth, etc.), roast nuts (e.g., peanuts, cashews, pecans, almonds, etc.), roast seeds (e.g., sunflower seeds, pumpkin seeds, lotus seeds, chickpeas, etc.), etc. The teachings of the present technology provided herein can be applied to other systems, not necessarily the system described herein. The elements and acts of the various embodiments described herein can be combined to provide further embodiments. Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

What is claimed is:

1. A popcorn making system, comprising:
a corn kernels preheating assembly configured to preheat corn kernels in a first medium without popping the corn kernels; and
a popping assembly positioned downstream of the corn kernels preheating assembly, wherein the popping assembly is configured to receive the preheated corn kernels from the corn kernels preheating assembly and further heat the preheated corn kernels in a second medium until the corn kernels pop,
wherein the second medium is different from the first medium.

2. The popcorn making system of claim 1, wherein the first medium is in a gaseous phase, and wherein the second medium is in a liquid phase.

3. The popcorn making system of claim 1, wherein the first medium is air, and wherein the second medium is oil.

4. The popcorn making system of claim 1, wherein the corn kernels preheating assembly includes:
a perforated drum positioned to receive the corn kernels;
a first moving device disposed inside the drum and configured to move the corn kernels through the perforated drum;
an air mover positioned external to the perforated drum; and
a heater positioned external to the perforated drum, wherein the air mover and the heater are configured to preheat the corn kernels moving through the drum in the first medium.

5. The popcorn making system of claim 1, wherein the corn kernels preheating assembly is configured to preheat the corn kernels to a preheating temperature between 400-500° F.

6. The popcorn making system of claim 1, wherein the popping assembly is configured to heat the preheated corn kernels to a popping temperature between 400-600° F.

7. The popcorn making system of claim 1, wherein the corn kernels preheating assembly is configured to preheat the corn kernels to a preheating temperature, and wherein the popping assembly is configured to heat the preheated corn kernels to a popping temperature higher than the preheating temperature.

8. The popcorn making system of claim 1, further comprising at least one of:
an oil preheating assembly configured to preheat the second medium; or
a seasoning preheating assembly configured to preheat seasoning,
wherein the popping assembly is configured to receive at least one of (i) the preheated second medium from the oil preheating assembly or (ii) the preheated seasoning from the seasoning preheating assembly.

9. The popcorn making system of claim 1, further comprising at least one of:
a corn kernels feed assembly configured to provide the corn kernels to the corn kernels preheating assembly at a first desired rate;
an oil feed assembly configured to provide the second medium to the oil preheating assembly at a second desired rate; or
a seasoning feed assembly configured to provide the seasoning to the seasoning preheating assembly at a third desired rate.

10. A method of making popcorn, the method comprising:
preheating, via a preheating assembly, corn kernels in a first medium to a preheating temperature without popping the corn kernels;
transferring the preheated corn kernels from the preheating assembly to a popping assembly;
transferring a second medium to the popping assembly, wherein the second medium is different from the first medium;
moving the preheated corn kernels and the second medium through the popping assembly; and
heating, via the popping assembly, the preheated corn kernels in the second medium to a popping temperature, thereby popping the corn kernels.

11. The method of claim 10, wherein preheating the corn kernels comprises preheating the corn kernels during a residence time between 10-50 seconds.

12. The method of claim 10, wherein moving the preheated corn kernels comprises moving the preheated corn kernels through the popping assembly during a residence time between 50-100 seconds.

13. The method of claim 10, wherein preheating the corn kernels comprises:
moving the corn kernels through a perforated drum of the preheating assembly; and
moving the first medium through and across the perforated drum such that the first medium contacts and thereby preheats the corn kernels to the preheating temperature.

14. The method of claim 10, wherein preheating the corn kernels comprises causing fluidization of the corn kernels and thereby improving uniform preheating of the corn kernels.

15. The method of claim 10, further comprising:
measuring a moisture content of a sample of the corn kernels; and
optimizing preheating parameters of the preheating assembly based on the measured moisture content.

16. The method of claim 10, wherein the first medium is air, and wherein the second medium is cooking oil.

17. The method of claim 10, wherein the preheating temperature is between 400-500° F., and wherein the popping temperature is between 400-600° F.

18. An auger assembly, comprising:
a shaft;
an auger coupled to and extending along at least a portion of a length of the shaft, wherein the auger includes a ribbon flighting zone, a full flighting zone, and a plurality of flights, wherein the auger includes a plurality of openings sized to provide visualization of spaces between the plurality of flights, wherein a ratio between a length of the ribbon flighting zone and a length of the full flighting zone is between 0.5:1-2:1; and
one or more agitators each including a wire coupled between peripheral edges of adjacent ones of the plurality of flights, wherein the agitators are configured to contact ingredients and thereby increase mixing of the ingredients.

19. The auger assembly of claim 18, wherein the one or more agitators each further include a plurality of protrusions extending from the wire and generally toward the shaft.

20. The auger assembly of claim 18, wherein:
the auger is positionable adjacent to a trough, and
the wire of each of the one or more agitators (i) is coupled to the auger at a first connection point and a second connection point at a different circumferential angle relative to the shaft, and (ii) has a curvature corresponding to the trough.
